(19) United States
(12) Patent Application Publication
(10) Pub. No.: US 2025/0219874 A1
(43) Pub. Date: Jul. 3, 2025

(54) MACHINE LEARNING FOR WIRELESS CHANNEL ESTIMATION

(71) Applicant: QUALCOMM Incorporated, San Diego, CA (US)

(72) Inventors: Fabio Valerio MASSOLI, Amsterdam (NL); Arash BEHBOODI, Amsterdam (NL); Christos LOUIZOS, Amsterdam (NL); Joseph Binamira SORIAGA, San Diego, CA (US)

(21) Appl. No.: 18/846,537

(22) PCT Filed: Jan. 31, 2023
(86) PCT No.: PCT/US2023/061666

§ 371 Date: Sep. 12, 2024

(30) Foreign Application Priority Data
May 19, 2022 (GR) 20220100416

(51) Int. Cl. H04L 25/02

(52) U.S. Cl. CPC H04L 25/0254

(57) ABSTRACT

Certain aspects of the present disclosure provide techniques and apparatus for wireless channel estimation using machine learning. A current sparsifying dictionary is generated by processing a sensing matrix and a current channel observation for the digital communication channel using a posterior neural network in a first iteration of a machine learning model, and a current sparse channel representation is generated by processing the current sparsifying dictionary, the sensing matrix, and the current channel observation using a likelihood neural network in the first iteration.

### CROSS-REFERENCE TO RELATED APPLICATIONS

This application claims priority to Greek Patent Application No. 20220100416, filed May 19, 2022, the entire contents of which are incorporated herein by reference.

### INTRODUCTION

Aspects of the present disclosure relate to machine learning for wireless channel estimation.

Wireless communication channels can have a variety of dynamic properties that affect how the signal propagates from the transmitter to the receiver. Such properties are often referred to collectively as channel state information (CSI), and determining or estimating such properties may be referred to as channel estimation. Accurate channel estimation allows for adapting of the wireless transmission based on channel conditions, which can significantly improve communication reliability and throughput, particularly when multiple antennas are used, such as in multiple-input multiple-output (MIMO) systems. However, channel estimation is an underdetermined problem (e.g., a problem where there are enough unknowns such that one cannot conclusively determine values for all of the problem parameters) in many deployments (such as millimeter-wave (mmWave) massive MIMO systems that use analog beamforming). As a result, channel estimations are often inaccurate or computationally expensive to perform or are simply unavailable.

### BRIEF SUMMARY

Certain aspects provide a processor-implemented method for performing channel estimation of a digital communication channel using a machine learning model, comprising: generating a current sparsifying dictionary by processing a sensing matrix and a current channel observation for the digital communication channel using a posterior neural network in a first iteration of the machine learning model; and generating a current sparse channel representation by processing the current sparsifying dictionary, the sensing matrix, and the current channel observation using a likelihood neural network in the first iteration.

Certain aspects provide a processor-implemented method for training a machine learning model for channel estimation of a digital communication channel, comprising: receiving a sensing matrix and a current channel observation for the digital communication channel; generating a current sparsifying dictionary by processing the sensing matrix and current channel observation using a posterior neural network; generating a current sparse channel representation by processing the current sparsifying dictionary, the sensing matrix, and the current channel observation using a likelihood neural network; generating a first loss by processing the current sparsifying dictionary using a prior neural network; generating a second loss based on the current channel estimation; and refining the posterior neural network, the likelihood neural network, and the prior neural network based on the first loss and the second loss.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example environment for improved channel estimation using machine learning.

FIG. 2 depicts an example architecture for machine learning models to perform improved channel estimation.

FIG. 3 depicts an example workflow to train machine learning models to perform channel estimation.

FIG. 4 depicts an example workflow to perform channel estimation using trained machine learning models.

FIG. 5 is a flow diagram depicting an example method for training machine learning models for channel estimation.

FIG. 6 is a flow diagram depicting an example method for performing channel estimation using machine learning models.

FIG. 7 is a flow diagram depicting an example method for generating channel estimations.

FIG. 8 is a flow diagram depicting an example method for training machine learning models for channel estimation.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for machine-learning-based channel estimation.

Channel estimation can be a significant technical problem in a variety of wireless communication systems, and particularly in MIMO wireless systems. Although some examples described in the present disclosure involve using machine learning to improve channel estimations in mmWave (e.g., communications in frequency bands above 24 GHz, where the wavelength is on the order of millimeters) systems, beamforming systems, and/or MIMO systems, aspects of the present disclosure are readily applicable to any estimation problem with underdetermined measurements. For example, aspects of the present disclosure may be used to improve magnetic resonance imaging (MRI) and other imaging problems.

A variety of compressed sensing techniques have been used in the context of mmWave and massive MIMO channel estimation, but the channel estimation problem remains an underdetermined problem. For example, in systems using analog beamforming, the channel observations are generally a lower dimensionality representation of a relatively higher-dimension channel. To provide improved estimations, some compressed sensing techniques attempt to leverage sparsity of the channel in the angular domain (rather than an antenna-focused domain). That is, the channel may be relatively dense in the spatial domain (e.g., with most elements having similar values and with little or no structure). In the angular domain, however, the channel is generally sparse (with most elements having a low or null value) and structured (with few elements having significant values). For example, the outer product of antenna responses on the transmit side and the receive side may be used as atoms or elements of a sparsifying dictionary that can be used to provide compressed sensing and channel estimations. In some aspects, the channel can be represented as the product between a sparsifying dictionary Ψ and a sparse vector representation of the signal, where the sparsifying dictionary corresponds to the angular domain of the transmitter and receiver. In some aspects of the present disclosure, the sparsifying dictionary can be generated using machine learning models based on observed channel information and corresponding sensing matrices Φ (which may correspond to the beamforming matrices or codebooks used to transmit/receive the signal, as discussed in more detail below).

Generally, conventional approaches for solving this compressed sensing problem involve a number of complications or tradeoffs, such as iterative methods like orthogonal matching pursuit (OMP) techniques, iterative hard-thresholding algorithm (IHTA) based techniques, iterative soft-thresholding algorithm (ISTA) techniques, and approximate message-passing (AMP) techniques. The hyperparameters of such algorithms (e.g., the number of iterations and the thresholds) can be manually tuned to attempt to optimize the performance/complexity trade-off, but at least some conventional approaches remain significantly limited in their flexibility and accuracy.

Some machine learning methods have been used to attempt to learn sparse recovery algorithms from sample data. For example, methods like learned ISTA (LISTA) and variations have focused on solving the problem using fixed sensing matrices (also referred to as measurement matrices) and sparsifying dictionaries. That is, such conventional approaches use static sparsifying dictionaries and static sensing matrices, whereas realistic deployments are generally significantly more dynamic. Use of such fixed approaches results in inherently limited estimations, preventing accurate and reliable channel estimations in a wide variety of realistic deployments.

Conventional approaches to provide MIMO channel estimation generally suffer from a variety of issues, including the lack of a ground-truth dictionary for the channel recovery, inability to adapt the sparsifying dictionary to different sensing matrices (also referred as measurement matrices in some aspects), a fixed number of iterations/layers (often incurring increased computational expense, as compared to a more flexible approach), inability to understand whether a dictionary remains valid or is out of distribution, inability determine when retraining should be performed, and the like.

In aspects of the present disclosure, techniques are provided to consider the channel in its full generality (e.g., with planar dual polarization antenna arrays in three-dimensional space). However, the dimensionality of such problems expands rapidly in these deployments, which makes the sparse recovery problem significantly more complex. In some aspects, to reduce or handle such complexity, a variational-LISTA (V-LISTA) approach is introduced. In some aspects of the present disclosure, augmented dictionary learning ISTA (A-DLISTA) architectures are used. In some aspects, the A-DLISTA architecture can be implemented as a single block that is iterated multiple times, and/or as an unrolled version of ISTA (e.g., using one or more sequential blocks, each having one or more neural networks to perform the processing operations). Aspects described herein utilize Bayesian formulations for the system in order to define a distribution over the dictionaries that can be updated at each iteration. To do so, in some aspects, the system generates and uses a prior distribution over the dictionaries, a likelihood function for the observed data, and a variational posterior which approximates the true posterior over the dictionaries. In some aspects, the likelihood function is used to generate a distribution based on learned parameters and generated sparsifying dictionaries. This distribution can then be used as the channel estimation, and/or as a sparse channel representation (which can be used to generate the channel estimation, as discussed below in more detail).

In contrast to at least some conventional techniques, aspects of the present disclosure can enable adaptation of the sparsifying dictionary to the specific input sensing matrices, a variable number of iterations (allowing for dynamic stopping during inferencing, when certain criteria are met), recognition of out of distribution dictionaries, understanding of when re-training is useful or advantageous, and the like. Each of these can significantly improve the accuracy and performance of the models and better represent realistic systems, as well as substantially reducing computational expense of the models.

### Example Environment for Channel Estimation Using Machine Learning

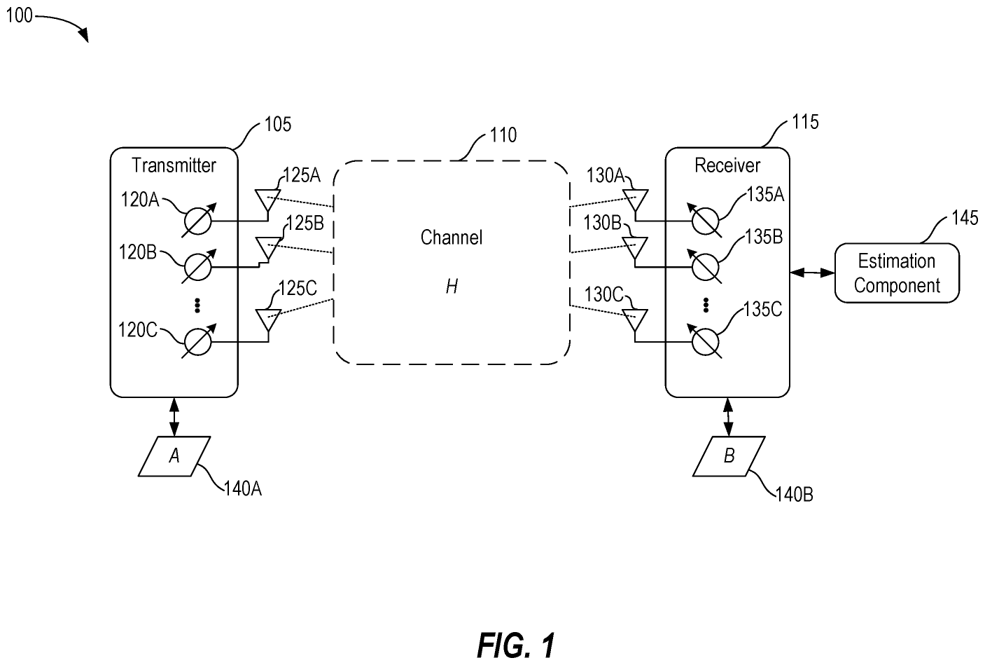

FIG. 1 depicts an example environment 100 for improved channel estimation using machine learning. In the illustrated example, the environment 100 is a MIMO system using analog beamforming to provide wireless communications. In at least one aspect, the environment 100 corresponds to a mmWave MIMO system.

As illustrated, the environment 100 includes a transmitter 105 and a receiver 115 communicating via a channel 110. In the depicted example, the transmitter 105 uses a set of transmitting antennas 125A-125C, while the receiver 115 uses a set of receiving antennas 130A-130C. Although three antennas are depicted on each system, the transmitter 105 and receiver 115 can generally use any number of antennas. Additionally, although the illustrated example depicts a single transmitter 105 and receiver 115, in some aspects, each device may operate as both a transmitter and receiver (e.g., a transceiver). Further, though not included in the illustrated example, in some aspects, some or all of the antennas of the transmitter 105 and/or receiver 115 may be arranged into one or more discrete subarrays. In at least one aspect, the transmitter 105 corresponds to a wireless base station, such as a 5G radio base station (e.g., a gNodeB), while the receiver 115 corresponds to user equipment.

In some aspects, the transmitter 105 (acting as a base station or BS) can wirelessly communicate with (e.g., transmit signals to or receive signals from) user equipments (UEs), such as receiver 115, via communications links (e.g., via channel 110). The communications links between BSs and UEs may include uplink (UL) (also referred to as reverse link) transmissions from a UE to a BS and/or downlink (DL) (also referred to as forward link) transmissions from a BS to a UE. The communications links may use multiple-input and multiple-output (MIMO) antenna technology, including spatial multiplexing, beamforming, and/or transmit diversity in various aspects.

BSs (such as the transmitter 105) may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each BS may provide communications coverage for a respective geographic coverage area, which may sometimes be referred to as a cell, and which may overlap in some cases (e.g., a small cell may have a coverage area that overlaps the coverage area of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home), and/or other types of cells.

In some aspects, the receiver 115 is part of a UE. In aspects, UEs may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

In the depicted environment 100, the transmitter 105 and receiver 115 each respectively use a set of phase shifters 120 (e.g., 120A-120C) and 135 (e.g., 135A-135C) to provide analog beamforming according to beamforming codebooks 140A and 140B. Specifically, each transmitting antenna 125 of the transmitter 105 has a corresponding phase shifter 120, and each receiving antenna 130 of the receiver 115 has a corresponding phase shifter 135. As discussed above, the use of multiple antennas on each side of the transmission (e.g., the fact that the environment 100 depicts a MMO system) and the use of analog beamforming (using phase shifters 120 and 135) significantly increases the complexity of performing channel estimation.

The channel 110 generally represents the wireless medium through which the signal propagates from the transmitter 105 to the receiver 115. The properties of the channel 110 can significantly affect how the signal propagates. As such, channel estimation using machine learning may be used to determine, predict, or infer the state of the channel 110. In some aspects, the signal observed by the receiver 115 may be formulated as Y=AHB, where Y is the observed signal (also referred to as a channel observation in some aspects), A and B are analog beamforming codebooks 140A and 140B (also referred to as beamforming matrices) used by the transmitter 105 and receiver 115, respectively (which may be proprietary and/or changing over time), and H represents the channel 110. In one such formulation, the goal of channel estimation is to estimate or predict H based on the channel observation Y.

In the illustrated example, an estimation component 145 is communicably coupled with the receiver 115. Although depicted as a discrete component for conceptual clarity, in some aspects, the estimation component 145 is integrated into the receiver 115. In some aspects, the estimation component may use machine learning and Bayesian statistics to provide channel estimations for the channel 110, for example, as discussed in more detail below. Additionally, though depicted as coupled with the receiver 115, in some aspects, the estimation component 145 may be integrated with or coupled to other components, such as the transmitter 105.

In some conventional systems, the channel estimation is determined based on various data including the element response matrices of the receiver 115 and transmitter 105 computed at two-dimensional angular grid points, where the response matrices can be used to define the sparsifying dictionary that is used to reconstruct the channel. That is, conventional approaches generally rely on knowledge of the response matrices (e.g., the antenna element response at any given direction) to define a fixed and static sparsifying dictionary. In contrast, aspects of the present disclosure enable the sparsifying dictionary to be generated using machine learning, as discussed in more detail below. Additionally, as discussed above, conventional systems generally rely on use of a fixed measurement or sensing matrix, while aspects of the present disclosure enable varying sensing matrices.

In some aspects, the use of a varying sensing matrix may be especially useful in the context of MIMO systems and beamforming systems. As aspects of the present disclosure do not require a priori knowledge about the sparsifying set of basis vectors for the signal to be recovered, nor do aspects of the present disclosure require the sparsifying dictionary to be fixed, the techniques described herein can significantly improve model performance and accuracy. In some aspects, the channel 110 is estimated by using trained neural networks to generate priors, posteriors, and/or likelihood models, rather than using a computed dictionary. For example, the estimation component 145 may use a neural network to define the parameters of a prior distribution over sparsifying dictionaries generated at each iteration of the model, and similarly use a neural network to define the parameters of a variational posterior distribution over the dictionaries. Similarly, a neural network (e.g., an A-DLISTA model) can be used as the likelihood model to generate channel estimations (e.g., distributions having parameters that are generated using A-DLISTA) at each iteration based on the generated sparsifying dictionary.

In some aspects, rather than operating on the channel estimate directly, the disclosed models can be used to receive and/or generate sparse channel representations, as discussed in more detail below. In some aspects, the sparse channel representation and the channel estimation itself are related or correlated, such that matrix multiplication can be used to generate the channel estimation based on the sparse representation. For example, in some such aspects, a channel estimation ĥ can be generated by performing matrix multiplication between the sampled sparsifying dictionary Ψ and the sparse channel representation \hat{x}, as discussed in more detail below.

Once the model(s) are trained (as discussed below), the model can be used to generate sparse channel representations that can then be used to generate channel estimations that can drive a variety of further operations to improve the functionality of the network/environment 100. For example, by estimating the channel 110, the estimation component 145 can enable improved analog beamforming design, faster beam selection, improved spectral efficiency prediction, sensing or positioning (e.g., locating objects in the space), link adaptation, communication parameter selection, and the like. For example, the estimated channel can be used to design the beamforming codebooks used by the transmitter and/or receiver to achieve better end-to-end performance.

Although channel estimation is used as one example use of the disclosed architectures and techniques, aspects of the present disclosure are readily applicable to a wide variety of compressed sensing problems.

### Example Architecture for Machine Learning Models for Channel Estimation

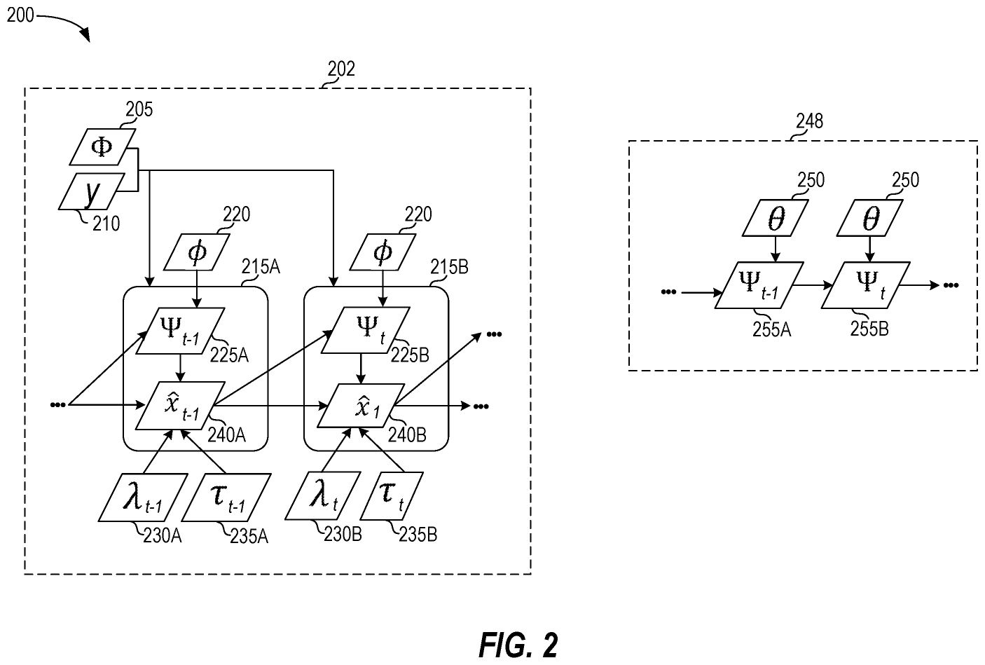

FIG. 2 depicts an example architecture 200 for machine learning models to perform improved channel estimation. In some aspects, the architecture 200 is used by an inferencing system to perform channel estimation during runtime. For example, the architecture 200 may be used by an estimation component, such as estimation component 145 of FIG. 1.

As discussed below in more detail, the architecture 200 can generally use a supervised training approach to refine the parameters of the models based on training exemplars, where each exemplar includes a channel observation y, denoted as observation 210 in the illustrated example (e.g., a specific observed data sample of the received signal Y), a corresponding sensing matrix (Φ) 205, and a ground-truth or known channel state h. Generally, the channel observation 210 corresponds to the signal observed at a receiver (e.g., receiver 115 of FIG. 1). The sensing matrix 205 is a function of the beamforming matrices (which are often proprietary designs and are generally known to the receiver and transmitter devices) used for the measurement or signal observation. In some aspects, the sensing matrix 205 is the Kronecker product of the two beamforming codebooks. For example, in at least one aspect, the sensing matrix 205 is defined as B^{T} ⊗A, where B^{T} is the transpose of matrix B (which may correspond to the beamforming codebook of the receiver used to observe the observation 210, as discussed above), and A is the beamforming codebook of the transmitter used to generate the transmission.

As discussed above, in contrast to at least some conventional approaches, the architecture 200 enables the sensing matrix 205 to differ or vary. That is, each observation 210 may have a corresponding sensing matrix 205, rather than using a fixed sensing matrix for all samples. This can improve the flexibility and accuracy of the model, as compared to at least some conventional approaches. Similarly, the architecture 200 enables the sparsifying dictionary to be adapted to different sensing matrices, thereby improving model accuracy.

The architecture 200 generally depicts first portion 202 corresponding to the posterior model and likelihood model, as discussed in more detail below, as well as a second portion 248 corresponding to the prior model, as discussed in more detail below.

In the illustrated example, the first portion 202 includes a sequence of blocks 215A-215B (collectively, blocks 215) (where the ellipses before and after the blocks 215 indicate that any number of blocks may be used, including a single block/iteration). Each block 215 generally corresponds to an application of a posterior model and a likelihood model, as discussed in more detail below. Although depicted as a discrete sequence of blocks 215 for conceptual clarity, in some aspects, the first portion 202 may be implemented as a single block, where the data is passed through the block iteratively. That is, the output of one iteration (e.g., block 215A) may be used as input to the same block for the next iteration. In aspects of the present disclosure, the blocks 215 may alternatively be referred to as layers (e.g., of a machine learning model or neural network), iterations, and the like.

Similarly, in the illustrated example, the second portion 248 includes a sequence of blocks 255A-255B (255) (where the ellipses before and after the blocks 255 indicate that any number of blocks may be used, including a single block/iteration). In some aspects, there may be one or more logic blocks or components (not depicted) to control existing of the loop/sequence. Each block 255 generally corresponds to an application of a prior model, as discussed in more detail below. Although depicted as a discrete sequence of blocks 255 for conceptual clarity, in some aspects, the second portion 248 may be implemented as a single block, where the data is passed through the block iteratively. That is, the output of one iteration (e.g., block 255A) may be used as input to the same block for the next iteration. In aspects of the present disclosure, the blocks 255 may alternatively be referred to as layers (e.g., of a machine learning model or neural network), iterations, and the like. Additionally, though depicted as discrete portions 202 and 248 for conceptual clarity, in some aspects, the second portion 248 (e.g., the blocks 255) may be incorporated in the first portion 202 (e.g., within the blocks 215).

In some aspects of the present disclosure, a conditional prior is defined over the sparsifying dictionaries, where the prior for the dictionary at a given iteration is conditioned on the dictionary sampled form the previous iteration. That is, as illustrated, the sparsifying dictionary from a first iteration (depicted in block 255A as Ψₜ₋₁) can be used as the condition for the prior distribution at the subsequent iteration (depicted in block 255B as Ψₜ). In some aspects, as discussed in more detail below, a machine learning model (e.g., a neural network) f_{θ} is used to define the conditional prior over the dictionaries. That is, the neural network f_{θ} may be used to generate the parameters of the priors over the dictionaries, where the model is characterized by learnable parameters θ. In the illustrated example, this is depicted as parameters 250 (illustrated as 0) being provided as input to define the prior distributions.

In at least one aspect, in the case of the first iteration (e.g., where a dictionary from the previous iteration is not available), the inferencing system sets the prior to be an unconditional standard Gaussian distribution. For subsequent iterations, the prior can be given by a Gaussian distribution having a mean and variance generated using a neural network, as discussed in more detail below.

In some aspects, the joint prior (over T iterations) is defined using Equation 1, below, where p_{θ} is the prior distribution, Ψₜ is the sparsifying dictionary at iteration t, Ψ_{1:T} is the sparsifying dictionaries from the first through the T-th, p(Ψ₁) is the sparsifying dictionary at the first iteration (e.g., [symbol] (0, 1)), and p_{θ}(Ψₜ|Ψₜ₋₁) represents the conditional prior at iteration t based on the dictionary from the prior iteration at t−1.

$${p}_{θ} ( {Ψ}_{1 : T} ) = p ( {Ψ}_{1} ) {\prod }_{t = 2}^{T} {p}_{θ} ( {Ψ}_{t} \vert {Ψ}_{t - 1} ) \qquad ( 1 )$$

At any given iteration t, in some aspects, the conditional prior can be defined as p_{θ}(Ψₜ|Ψₜ₋₁). In some aspects, as discussed above, the conditional prior is implemented as a Gaussian distribution with parameters (e.g., mean and standard deviation or variance) defined by a machine learning model, such as a neural network. For example, in some aspects, the conditional prior at iteration t is defined using Equation 2, below, where [symbol] represents a Gaussian distribution, μ is the mean of the distribution, σ² is the variance, and f_{θ}(Ψₜ₋₁) represents processing the previous sparsifying dictionary Ψₜ₋₁ using neural network f_{θ}. That is, the mean μ and variance σ² of the prior p_{θ} are generated by processing the previous sparsifying dictionary using a trained neural network, as discussed in more detail below.

$${p}_{θ} ( {Ψ}_{t} \vert {Ψ}_{t - 1} ) = ( μ = {f}_{θ} ( {Ψ}_{t - 1} ) ; {σ}^{2} = {f}_{θ} ( {Ψ}_{t - 1} ) \qquad ( 2 )$$

As discussed in more detail below, the second portion 248 (corresponding to the prior distribution) may be used during training of the model. During inferencing (e.g., when generating channel estimations during runtime), the second portion 248 may be unused, and the inferencing system may use only the posterior and likelihood models to generate estimations, as discussed in more detail below.

In the illustrated architecture 200, the first portion 202 corresponds to use of the posterior distribution (defined using another neural network) and likelihood model. In the illustrated example, at each block 215, a set of parameters 220 (denoted as p) corresponding to the neural network used to define the posterior distribution are received, alongside the input data (e.g., the observation 210 and sensing matrix 205). Each block 215 also receives a corresponding set of parameters 230 and 235, which define the likelihood model, as discussed in more detail below. As further illustrated, each block 215 receives a sparse channel representation 240 (240A, 240B) generated by the previous iteration/block.

Specifically, as illustrated, the sparse channel representation 240A from a first iteration or block 215A is processed (e.g., by the posterior neural network) to generate a sparsifying dictionary 225B at the second iteration or block 215B based at least in part on the corresponding posterior network parameters 220. Specifically, in some aspects, the neural network generates the parameters of the posterior distribution, which is sampled to generate the sparsifying dictionary 225B at the block 215B. In some aspects, the input observation 210 and sensing matrix 205 are also used as input to the posterior neural network to generate the corresponding posterior distribution parameters, as discussed in more detail below. In the first iteration/layer, there is no previous iteration, and therefore no previous sparse channel representation. In at least one aspect, in the first iteration, the inferencing system defines \hat{x}₀ as a value/vector of zero and uses this as input to the posterior network.

As illustrated, the sampled sparsifying dictionary 225B is then provided as input to a likelihood model to generate a current sparse channel representation 240B at iteration or block 215B, based at least in part on corresponding likelihood model parameters 230B and 235B. In at least one aspect, the likelihood model is an A-DLISTA model defined by learnable parameters 230 (e.g., a soft thresholding value) and 235 (e.g., a step size). In the illustrated example, each iteration or block 215 has a corresponding set of likelihood model parameters 230 and 235 (e.g., where the parameters 230A and 235A for iteration or block 215A may differ from parameters 230B and 235B for iteration or block 215B). In some aspects, the parameters 230 and 235 are shared across iterations or blocks 215.

Additionally, in the illustrated example, the posterior parameters 220 are shared across the iterations or blocks 215. In some aspects, each iteration or block 215 may use a corresponding unique set of learned parameters 220, as discussed in more detail below. Similarly, in the illustrated example, the prior parameters 250 are shared across the iterations or blocks 255. In some aspects, each iteration or block may use a corresponding unique set of learned parameters 250, as discussed in more detail below.

In some aspects, the likelihood model is used to generate the sparse channel representations 240, and defines the probability over the sparse representation at iteration t and is conditioned on the previously sampled dictionaries as well as from the input data (observation 210 and sensing matrix 205). In some aspects, the likelihood model is defined using Equation 3, below, where p_{Θ} represents the likelihood model parametrized by parameters learnable parameters Θ (which may include parameters 230 and 235), \hat{x}ₜ is the generated sparse channel representation at iteration t, x_{gt} is a ground-truth sparse channel representation that corresponds to the input observation 210 and sensing matrix 205 (e.g., generated based on a ground-truth channel estimate reflecting the actual state of the channel when the observation 210 was recorded), Ψ_{1:t} is the sparsifying dictionaries generated in iterations one through t, y is the input observation 210, and 0 is the corresponding sensing matrix 205.

$${p}_{Θ} ( {\hat{x}}_{t} = {x}_{g t} \vert {Ψ}_{1 : t} , y , Φ ) \qquad ( 3 )$$

In some aspects, as discussed above, the likelihood model is implemented using a machine learning model (e.g., a neural network), such as an A-DLISTA model. In some such aspects, the likelihood model is implemented using a Gaussian distribution with parameters (e.g., mean and variance) defined by the trained model. For example, the likelihood model may be defined using Equation 4, below, where [symbol] represents a Gaussian distribution, μ is the mean of the distribution, σ² is the variance, and LISTA(Ψ_{1:t}, y, Φ; Θ) represents processing the set of previous sparsifying dictionaries Ψ_{1:t}, the observation 210, and the sensing matrix Φ using an A-DLISTA machine learning model parameterized by learnable parameters Θ. That is, the mean μ of the likelihood model po can be generated by processing the previous sparsifying dictionaries and input data using a trained neural network, as discussed in more detail below. In some aspects, the variance σ² is a hyperparameter of the architecture 200. In other aspects, the variance can also be a learned parameter. Using Equation 4, the inferencing system can generate a distribution having a mean defined using a neural network (e.g., an A-DLISTA model) and a fixed (e.g., hyperparameter) or learned variance. This distribution can then be returned as the sparse channel representation 240 of the current iteration (and, in some aspects, can be used to generate the channel estimation of the current iteration, as discussed above).

$$( μ = ADLISTA ( {Ψ}_{1 : t} , y , Φ ; Θ ) ; {σ}^{2} ) \qquad ( 4 )$$

In some aspects, the joint log-probability distribution for the channel and dictionaries at each iteration can be defined as log p_{{Θ,θ}}(Ψ_{1:T},\hat{x}_{1:T}=x_{gt}|y,Φ), and given by Equation 5, below, where Ψ_{1:T} is the set of sparsifying dictionaries generated in iterations one through T, \hat{x}_{1:T} is the sparse channel representations generated in iterations one through T, x_{gt} is the ground-truth sparse channel representation, and y and Φ are the channel observation and sensing matrix, respectively. In some aspects, the joint probability for the dictionaries and sparse channel representations represents the product between the likelihood and the prior distribution over the dictionaries. In some aspects, this joint probability can be used in formulation of the objective function used to train the model.

$${\sum }_{t = 1}^{T} log {p}_{Θ} ( {\hat{x}}_{1 : t} = {x}_{g t} \vert {Ψ}_{1 : t} , y , Φ ) + {\sum }_{t = 2}^{T} log {p}_{θ} ( {Ψ}_{t} \vert {Ψ}_{t - 1} ) + log p ( {Ψ}_{1} ) \qquad ( 5 )$$

In some aspects, the variational posterior is used to sample the sparsifying dictionaries 225, and is defined as a Gaussian distribution with parameters (e.g., mean and variance) that are generated using a machine learning model, such as a neural network (e.g., a posterior network). In some such aspects, the posterior distribution is defined as q_{ϕ}(Ψₜ|\hat{x}ₜ₋₁, y, Φ), where q_{ϕ} is the posterior distribution, Ψₜ is the sparsifying dictionary sampled at iteration t, \hat{x}ₜ₋₁ is the sparse channel representation generated at iteration t−1, y is the observation, and Φ is the sensing matrix. In some aspects, the posterior is implemented using a Gaussian distribution with parameters (e.g., mean and variance or standard deviation) defined by the trained model. For example, the posterior may be defined using Equation 6, below, where [symbol] represents a Gaussian distribution, y is the mean of the distribution, β⁻¹ is the precision of the distribution (e.g., the inverse of the variance), and f_{ϕ}(\hat{x}ₜ₋₁, y, Φ) represents processing the previous sparse channel representation \hat{x}ₜ₋₁ generated in the immediately-prior iteration, the observation 210, and the sensing matrix Φ using a machine learning model (e.g., a neural network) parameterized by learnable parameters ϕ. That is, the parameters μ and β⁻¹ of the posterior distribution can be generated by processing the previous sparse channel representation and input data using a trained neural network, as discussed in more detail below.

$$( μ = {f}_{ϕ} ( {\hat{x}}_{t - 1} , y , Φ ) ; {β}^{- 1} = {f}_{ϕ} ( {\hat{x}}_{t - 1} , y , Φ ) ) \qquad ( 6 )$$

In some aspects, the sampled sparsifying dictionary Ψₜ implicitly depends on Ψ_{1:t-1}, as the sparsifying dictionary Ψₜ at iteration t is generated/sampled using \hat{x}ₜ₋₁ (which, in turn, depends on Ψ_{1:t-1}).

### Example Workflow to Train Machine Learning Models for Channel Estimation

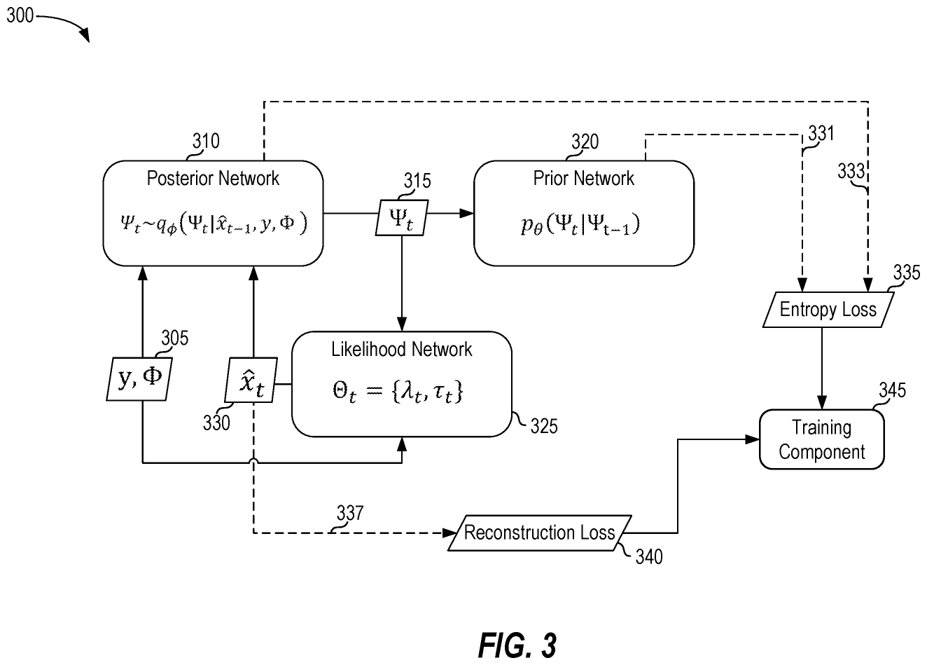

FIG. 3 depicts an example workflow 300 to train machine learning models to perform channel estimation. In some aspects, the workflow 300 is used by an estimation component, such as estimation component 145 of FIG. 1. In some aspects, the workflow 300 is used to provide offline training of machine learning models. The training can generally be performed by any suitable device or system, such as dedicated training systems.

As illustrated, the workflow 300 begins with a set of input data 305 including a channel observation y and corresponding sensing matrix (P. As illustrated, this exemplar input data 305 is provided as input to a posterior network 310 and likelihood network 325. The posterior network 310 is generally a machine learning model (e.g., a neural network) that learns to generate distribution parameters for a variational posterior distribution, as discussed above. In the illustrated example, the posterior network 310 also receives, as input, a sparse channel representation 330 which is generated using the likelihood network 325, discussed in more detail below. In some aspects, the posterior network receives the input data 305 and the sparse channel representation 330 that was generated in the previous iteration, layer, or block of the model, as discussed above. Specifically, as illustrated, the posterior network 310 processes the previous sparse channel representation \hat{x}ₜ₋₁ and input data 305 (y and Φ) to generate distribution parameters (e.g., mean and variance), and the training system uses these values to generate a posterior distribution q_{ϕ}(Ψₜ|\hat{x}ₜ₋₁, y, Φ). As illustrated, the training system can then sample this distribution (denoted as Ψₜ˜q_{Φ}(Ψₜ|\hat{x}ₜ₋₁, y, Φ) to generate a current sparsifying dictionary 315 (denoted Tt) for the current iteration.

In some aspects, the posterior network 310 comprises three input heads, with one for each input (e.g., one for the previous sparse channel representation \hat{x}ₜ₋₁) one for the observation y of the input data 305, and one for the sensing matrix Φ of the input data 305. In some aspects, the posterior network 310 further includes one or more subsequent layers shared by each input head (e.g., a linear layer). In some aspects, the posterior network 310 includes a set of branches after the shared layer(s), where each branch includes one or more layers (e.g., convolution layers) and outputs a corresponding value. For example, a first branch may generate the mean value while a second may generate the variance value for the distribution that the posterior network 310 represents.

In the illustrated example, this sampled sparsifying dictionary 315 is provided to both a prior network 320 and the likelihood network 325. As depicted and discussed above, the prior network 320 may process the current sparsifying dictionary Ψₜ and/or prior sparsifying dictionary Ψₜ₋₁ to generate distribution parameters, and thereby define the conditioned prior distribution p_{θ}(Ψₜ|Ψₜ₋₁). In some aspects, the prior distribution is used to help define the entropy loss 335 used to refine the architecture/model(s) (as indicated by dotted lines 331 and 333), as discussed below in more detail.

In some aspects, the prior network 320 comprises one input head for the single input (e.g., one for the sparsifying dictionary 315). In some aspects, in a similar manner to the posterior network 310, the prior network 320 further includes one or more subsequent layers (e.g., one or more convolution layers), followed by a set of branches after the shared layer(s), where each branch includes one or more layers (e.g., convolution layers) and outputs a corresponding value. For example, a first branch may generate the mean value while a second may generate the variance value for the distribution that the prior network 320 represents.

In the illustrated workflow 300, the likelihood network 325 also receives the sampled sparsifying dictionary 315 and uses this dictionary, along with the input 305, to generate the new sparse channel representation 330 (denoted \hat{x}ₜ) for the current iteration. As illustrated, the likelihood network 325 is parameterized by learnable parameters Θ, which may include a soft threshold λ and a step size τ, as discussed above. In some aspects, the likelihood network 325 corresponds to an A-DLISTA network. In the illustrated example, the likelihood network 325 may use a corresponding set of parameters Θₜ that are learned specifically for iteration t. That is, the model may learn a different set of parameters for each iteration/block. In other aspects, the parameters may be shared across iterations.

In some aspects, as discussed above, the likelihood network is used to generate one or more parameters of a likelihood distribution (e.g., a mean and/or variance). This distribution can then be returned as the sparse channel representation 330 for the current iteration.

As illustrated, the sparse channel representation 330 generated in the current iteration can be provided to the posterior network 310 in the subsequent or following iteration. In some aspects, the sparse channel representation 330 is also used to generate the reconstruction loss 340 (as indicated by dotted line 337), discussed in more detail below. In some aspects, the training system generates entropy loss 335 and reconstruction loss 340 at each iteration. That is, for each block or layer of the model, the training system may generate a corresponding entropy loss 335 and reconstruction loss 340, and use these losses to refine the model. In other aspects, the training system may generate the reconstruction loss 340 and entropy loss 335 only after the final iteration or layer has been processed to generate the final sparse channel representation from the model, given the input data 305.

In the illustrated example, the training component 345 can generate the losses and/or use the losses to refine the learned parameters of the prior network 320, posterior network 310, and likelihood network 325. In at least one aspect, the models are trained by maximizing the evidence lower bound (ELBO) (also referred to as the variational lower bound or the negative variational free energy, in some aspects). The ELBO can generally be used as a lower bound of the log-likelihood of the observed data. In at least one aspect, the ELBO is defined using Equation 7, below, where ELBO is the overall loss (which is maximized during training), Loss_{R} is the mean squared error for the reconstructed channel and/or sparse channel representation (assuming a Gaussian prior) defined using Equation 8, below, and Loss_{P1} and Loss_{P2} are Kullback-Leibler (KL) divergence among the variational posteriors and conditional priors at each iteration t, defined below in Equations 9 and 10, respectively. In some aspects, the training system can use a defined number of iterations (e.g., processing the input data 305 using a defined number of blocks or layers) for each input during training. The same number or a different number of iterations can then be used during inferencing, as discussed in more detail below.

$$ELBO = {Loss}_{R} - {Loss}_{P 1} - {Loss}_{P 2} \qquad ( 7 )$$

In some aspects, Equation 8, below is used to define the reconstruction loss 340. In some aspects, as discussed above, the reconstruction loss 340 is generated based at least in part on the sparse channel representation 330 (or, in some aspects, the corresponding channel estimate generated based on the sparse channel representation) for the current iteration (as indicated by dotted line 337). In Equation 8, Ψ_{1:t} is the sparsifying dictionaries sampled in layers one through t, y is the channel observation, Φ is the corresponding sensing matrix, \hat{x}_{0:t-1} is the sparse channel representations from layers/iterations zero (e.g., the first iteration) through t−1, \hat{x}ₜ is the sparse channel representation generated in iteration t, and x_{gt} is the ground-truth sparse channel representation (e.g., generated based on the ground-truth channel). Equation 8 generates a sum across the model layers/iterations from one through T. For each iteration, the training system may determine the expected value of the log-likelihood distribution, given the dictionary sampled from the posterior distribution.

$$Loss = {\sum }_{t = 1}^{T} {𝔼}_{{Ψ}_{1 : t} ∼ {q}_{ϕ} ( {Ψ}_{1 : t} \vert y , Φ {\hat{x}}_{0 : t - 1} )} [ log {p}_{Θ} ( {\hat{x}}_{t} = {x}_{gt} \vert {Ψ}_{1 : t} , y , Φ ) ] \qquad ( 8 )$$

In some aspects, Equation 9 below is used to define one part of the entropy loss 335. In some aspects, as discussed above, the entropy loss 335 is generated based at least in part on variational posterior distribution (generated using the posterior network 310 and as indicated by dotted line 333) and the generated prior distribution (generated using the prior network 320 and indicated by dotted line 331). In a similar manner to Equation 8, the sum in Equation 9 runs across the model from the second iteration through the final layer. For each layer, Equation 9 evaluates the expected value for the KL divergence between the variational posterior distribution (e.g., generated using the posterior network 310) and the prior distribution (e.g., generated using the prior network 320). In the below example, the sum can begin from the second layer, as Equation 10 below includes KL divergence for the first layer.

$${Loss}_{P 1} = {\sum }_{t = 2}^{T} {𝔼}_{{Ψ}_{1 : t - 1} ∼ {q}_{ϕ} ( {Ψ}_{1 : t - 1} \vert y , Φ , {\hat{x}}_{t - 1} )} [ {D}_{K L} ( {q}_{ϕ} ( {Ψ}_{t} \vert y , Φ , {\hat{x}}_{t - 1} ) ‖ {p}_{θ} ( {Ψ}_{t} \vert {Ψ}_{t - 1} ) ) ] \qquad ( 9 )$$

In some aspects, Equation 10 below is used to define one part of the entropy loss 335. For example, the entropy loss 335 may be defined as Loss_{P1}−Loss_{P2}. Using Equation 10, the training system can determine the KL divergence between the posterior and the prior distributions for the first layer/iteration of the model.

$${Loss}_{P 2} = {D}_{K L} ( {q}_{ϕ} ( {Ψ}_{1} \vert {\hat{x}}_{0} ) ‖ p ( {Ψ}_{1} ) ) \qquad ( 10 )$$

In some aspects, using the workflow 300, the training system is able to use a variational A-DLISTA approach to learn approximate sparsifying dictionaries for inverse problems (such as channel estimation), where the variational A-DLISTA approach defines uncertainties over LISTA parameters such as dictionaries, thresholds, and step-sizes. In some aspects, as discussed above, variational A-DLISTA enables the training system to adapt the dictionaries to differing measurements.

In some aspects, as discussed above, the training system can learn the sparsifying dictionary Ψ in its entirety. In at least one aspect, the training system may determine a component or subset of the sparsifying dictionary from other sources, and learn the remaining portions. For example, in some such aspects, the training system can receive the sparsifying dictionary used by the transmitting device (e.g., a base station) for the communication. As the overall sparsifying dictionary Ψ may be the Kronecker product of the receiver dictionary and transmitter dictionary, in some aspects, the training system can use the (known) transmitter dictionary to optimize learning of the overall sparsifying dictionary Ψ (e.g., to learn only the receiver-side dictionary). Similarly, the training system may receive the sparsifying dictionary of the receiving device, and learn the dictionary of the transmitter.

In some aspects, once a given input sample (including a sensing matrix, observation, and ground truth channel state and/or sparse channel representation) has been used to refine the models, subsequent samples may similarly be used to generate corresponding sparse channel representations 330 and losses 335 and 340. In aspects, this training workflow 300 can be performed using stochastic gradient descent (e.g., backpropagating each loss for each input sample individually) and/or batch gradient descent (e.g., refining the model based on loss generated for a batch of input samples).

Once training is complete, the model architecture can be used to generate sparse channel representations (which can then be used to generate channel estimations in some aspects) during runtime inferencing based on input channel observations and sensing matrices, as discussed in more detail below.

### Example Workflow for Channel Estimation Using Machine Learning Models

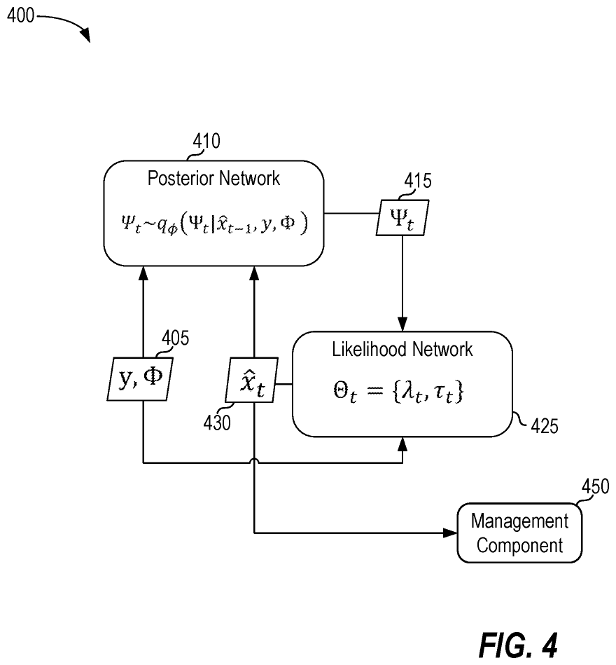

FIG. 4 depicts an example workflow to generate sparse channel representations (e.g., to perform channel estimation) using trained machine learning models. In some aspects, the workflow 400 is used by an estimation component, such as estimation component 145 of FIG. 1. In some aspects, the workflow 400 is used to provide runtime generation of sparse channel representations (which can be used to provide channel estimations) using trained machine learning models. In at least one aspect, the workflow 400 is performed by user equipment participating in the wireless communication (e.g., by the receiver 115 of FIG. 1 and/or by a device or system that includes or uses the receiver). Generally, the workflow 400 may be performed by any inferencing system.

The workflow 400 generally uses a trained machine learning model (e.g., networks trained using the workflow 300 of FIG. 3) to generate a sparse channel representation 430 based on input data 405 (including a channel observation and a corresponding sensing matrix). As discussed above, the channel observation generally corresponds to the signal perceived by a receiver (e.g., the receiver 115 of FIG. 1), and the sensing matrix is generally defined based on the beamforming codebooks used by the transmitter and receiver when the signal was observed.

The workflow 400 largely mirrors the workflow 300, with the exception that the prior network 320 of FIG. 3 is not used during inferencing, and that the management component 450 uses the generated sparse channel representations for various purposes (rather than the training component 345 using the predictions to refine the models).

As illustrated, the workflow 400 begins with a set of input data 405 including a channel observation y and corresponding sensing matrix Φ. As illustrated, this input data is provided as input to a posterior network 410 (which may correspond to the posterior network 310 of FIG. 3, once training is complete) and a likelihood network 425 (which may correspond to the likelihood network 325 of FIG. 3, once training is complete). As discussed above, the posterior network 410 is generally a machine learning model (e.g., a neural network) that learns to generate distribution parameters for a variational posterior distribution, as discussed above. In the illustrated example, the posterior network 410 also receives, as input, a sparse channel representation 430, which is generated by the likelihood network 425 discussed in more detail below. In some aspects, the posterior network receives the current input data 405 and the sparse channel representation 430 that was generated in the previous iteration, layer, or block of the model, as discussed above. Specifically, as illustrated, the posterior network 410 processes the previous sparse channel representation \hat{x}ₜ₋₁ and input data 405 (y and Φ) to generate distribution parameters (e.g., mean and variance), and the inferencing system uses these values to generate a posterior distribution q_{ϕ}(Ψₜ|\hat{x}ₜ₋₁, y, Φ). As illustrated, the inferencing system can then sample this distribution (denoted as Ψₜ˜q_{ϕ}(Ψₜ|\hat{x}ₜ₋₁, y, Φ) to generate a current sparsifying dictionary 415 for the current iteration.

In the illustrated example, this sampled sparsifying dictionary 415 is provided to the likelihood network 425. The likelihood network 425 uses the sampled sparsifying dictionary 415, along with the input data 405, to generate the new sparse channel representation 430 for the current iteration. As illustrated, the likelihood network 425 is parameterized by learned parameters Θ, which may include a soft threshold λ and a step size τ, as discussed above. In some aspects, the likelihood network 425 corresponds to an A-DLISTA network. In the illustrated example, the likelihood network 425 may use a corresponding set of parameters Θₜ that are learned specifically for iteration t. That is, the model may learn a different set of parameters for each iteration/block. In other aspects, the parameters may be shared across iterations.

As illustrated, the sparse channel representation 430 generated in the current iteration can be provided to the posterior network 410 in the subsequent or following iteration. As illustrated, the sparse channel representation 430 can also be selectively provided to the management component 450, discussed in more detail below. This sparse channel representation 430 can then be used for a variety of purposes, such as to generate a corresponding channel estimate, which enables operations such as improving the analog beamforming, beam selection, spectral efficiency prediction, and the like.

In the illustrated example, at inference time, the posterior is used to sample the dictionary, for each iteration, and the sparse channel representation is reconstructed by the likelihood model. In some aspects, the inferencing system uses the workflow 400 to iteratively generate new sparse channel representation 430 at each iteration/block/layer of the model until one or more defined termination criteria are met. In some aspects, the termination criteria relate to the number of iterations or layers that have been completed. In some such aspects, the inferencing system can generate new sparse channel representation 430 until a defined number of iterations (or blocks) have been processed. For example, if the model was trained using ten iterations, then the workflow 400 may iterate through an equal number of iterations (e.g., ten). After the tenth iteration, the sparse channel representation 430 may be provided to the management component 450 (rather than the posterior network 410). As discussed above, the management component 450 (or another component) can then use the sparse channel representation to generate a channel estimate (e.g., where the channel estimation ĥ is equal to the sampled sparsifying dictionary Ψ multiplied with the sparse channel representation \hat{x}).

In at least one aspect, the inferencing system can use one or more dynamic termination criteria to immediately output the current sparse channel representation 430, rather than continuing processing, in order to reduce computational expense and latency. In some such aspects, the inferencing system can determine the entropy of the likelihood (e.g., of the sparse channel representation/distribution generated using the likelihood network), and use this entropy to define the one or more stopping criteria for the iterative procedure in order to reduce the number of iterations. For example, if the determined entropy meets one or more defined criteria, then the inferencing system may output the current sparse channel representation/distribution, or may output a current channel estimation generated based on the current sparse channel representation (e.g., to the management component 450) and refrain from any further processing. That is, the inferencing system can refrain from providing the sparse channel representation 430 to the posterior network 410 for a subsequent iteration (or in a subsequent block) of processing. In some aspects, the one or more defined criteria can include determining whether the value of the entropy is equal to or less than a defined threshold, whether the difference between entropies of the likelihoods generated in successive layers is less than a threshold, and the like.

In this way, the inferencing system can use fewer iterations or blocks at runtime than were trained at training time. In contrast, for at least some conventional approaches, the inference uses the same number of iterations/blocks as the training. This dynamic on-line stopping can reduce the total number of iterations, thereby reducing latency and power consumption of the model.

Additionally, as discussed above, at each iteration, the distribution of sparsifying dictionaries is updated using a machine learning model (e.g., a neural network). In some aspects, this network can be used to provide uncertainty estimations at the output. For example, the inferencing system may evaluate the generated variance of the posterior distribution (generated by the posterior network). This uncertainty estimation can then be used for out-of-distribution detections (e.g., where the sample is considered to be out of distribution if the uncertainty meets or exceeds some threshold), as well as to make decisions regarding communication parameters and/or beam management procedures. Similarly, in some aspects, the uncertainty can be used to signal that re-training and/or fine-tuning the model may be advantageous. That is, when the uncertainty satisfies one or more defined criteria, the inferencing system may initiate a re-training or fine-tuning of the model to ensure high accuracy is maintained.

### Example Method for Training Machine Learning Models for Channel Estimation

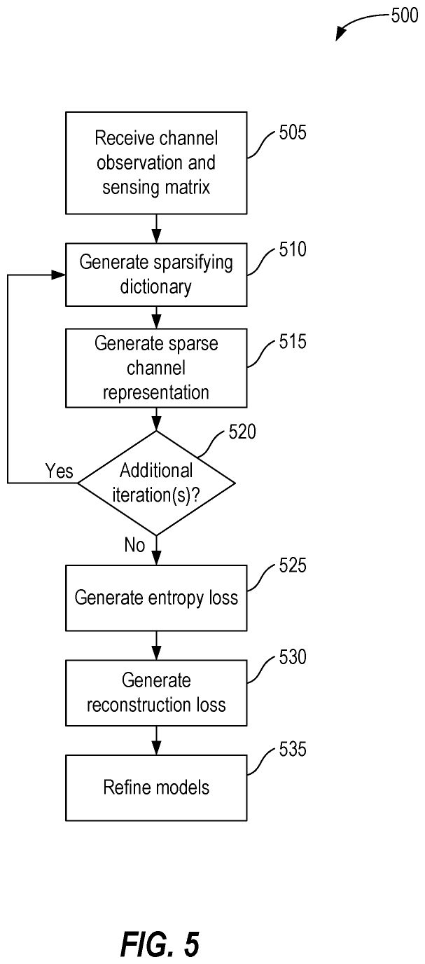

FIG. 5 is a flow diagram depicting an example method 500 for training machine learning models for generating sparse channel representations (e.g., for channel estimation). In some aspects, the method 500 is performed by an estimation component, such as estimation component 145 of FIG. 1. In some aspects, the method 500 is performed to provide offline training of one or more machine learning models, such as by a training device or system.

At block 505, the training system determines, identifies, receives, or otherwise accesses a training sample including a channel observation (e.g., observation 210 of FIG. 2), a sensing matrix (e.g., sensing matrix 205 of FIG. 2), and a ground-truth channel state (or a sparse channel representation, which can be generated based on the state). In some aspects, as discussed above, the channel observation corresponds to a wireless signal as observed or measured by a receiving device or system, the sensing matrix is defined based on the parameters used to transmit and/or receive the signal (e.g., the beamforming codebooks used by the transmitter and receiver), and the channel state corresponds to the properties of the wireless medium when the signal was transmitted.

In some aspects, the channel observation, sensing matrix, and channel state (or sparse channel representation) may generally be determined or received as part of a training sample or exemplar, as discussed above. By using such samples, the training system can iteratively refine the machine learning model (e.g., the posterior network, prior network, and likelihood model) to generate improved and more accurate sparse channel representations and channel estimations.

At block 510, the training system generates a current sparsifying dictionary for the current iteration. In some aspects, as discussed above, the training system generates the current sparsifying dictionary using a variational posterior distribution defined using parameters generated by a machine learning model (e.g., posterior network 310 of FIG. 3). In some aspects, as discussed above, the posterior network processes the input sensing matrix and observation, alongside the sparse channel representation generated in the previous iteration (if available), to generate the distribution parameters (e.g., the mean value and/or variance value). This distribution can then be sampled to generate the current sparsifying dictionary. In at least one aspect, as discussed above, in the first iteration (e.g., where no previous channel estimate is available), the training system can use a standard unconditional Gaussian distribution (e.g., [symbol] (0, 1)) as the posterior distribution, and sample this distribution to generate the sparsifying dictionary for the first iteration.

At block 515, the training system can then generate a sparse channel representation based at least in part on the generated sparsifying dictionary. In some aspects, the sparse channel representation is generated by a likelihood model (e.g., an A-DLISTA model). In some aspects, as discussed above, the training system generates the current sparse channel representation using a likelihood model and/or distribution defined using parameters generated by a machine learning model (e.g., likelihood network 325 of FIG. 3). In some aspects, as discussed above, the likelihood network processes the input sensing matrix and observation, alongside the current sparsifying dictionary generated in block 510, to generate the distribution parameters (e.g., the mean value and/or variance value). This distribution (defined by the generated parameters) can then be used as the sparse channel representation and/or can be sampled to generate the sparse channel representation.

At block 520, the training system determines whether there is at least one additional iteration, layer, or block remaining in the model. That is, the training system can determine whether the iteration processed at blocks 510 and 515 was the last or final iteration specified in the model architecture. If there is at least one additional iteration remaining, then the method 500 returns to block 510, where the training system can generate a new sparsifying dictionary based at least in part on processing the current sparse channel representation (which was generated at block 515 using the prior/initial sparsifying dictionary) using the next layer, block, or iteration of the model. In this way, the method 500 can proceed to process data through each iteration of the model, iteratively refining or updating the sparse channel representations as the sparse channel representations pass through each layer.

Although the illustrated example depicts the one or more termination criteria as a number of iterations, in some aspects, as discussed above, the training system may use one or more other criteria (such as the entropy of the likelihood model) to determine whether to process additional iterations.

If no further layers remain (or one or more other termination criteria are met), then the method 500 continues to block 525. At block 525, the training system generates an entropy loss based on the input training sample, as discussed above. For example, as discussed above, the training system may use Equations 9 and 10 to generate KL divergence losses among the variational posteriors and the conditional priors at each iteration of the model.

At block 530, the training system can then compute a reconstruction loss based on the sparse channel representation generated at block 515 (or based on a corresponding channel estimation generated based on the sparse channel representation) and the known sparse channel representation determined at block 505 (or the known channel state, as discussed above). For example, as discussed above, the training system may use Equation 8 to compute the normalized mean squared error between the sparse channel representation and/or channel estimation and the channel state. Although the illustrated example depicts generating the losses based on a single training sample (e.g., a single observation with corresponding sensing matrix and channel state), in some aspects, the training system can use batch training to generate loss based on multiple samples.

At block 535, the training system can then refine the various networks of the model (e.g., the posterior network, the prior network, and/or the likelihood network) based on the losses, as discussed above (e.g., using Equation 7). For example, the training system may use backpropagation to refine the parameters of each layer of each model, beginning with the final layer and moving towards the first. Generally, the method 500 can be used to refine the neural network models using any number and variety of training samples.

In some aspects, as discussed above, the training system can train or refine a separate set of parameters for each iteration, layer, or block of the model. That is, each respective iteration may have a respective set of parameters for the likelihood model (e.g., a learned step size and/or learned threshold value), a respective set of parameters for the posterior model, and/or a respective set of parameters for the prior model. In other aspects, the training system may use a set of shared parameters for one or more of the individual networks across the iterations, as discussed above.

By using the method 500, the training system can train the model to generate significantly improved sparse channel representations, resulting in more accurate channel estimations, particularly for MIMO systems and/or systems using analog beamforming. Additionally, as discussed above, the trained model can generally use sparsifying dictionaries having lower dimensionality, as compared to at least some conventional approaches, enabling the models to be used by devices or systems with more limited computational or power resources, such as low-powered user equipment.

### Example Method for Channel Estimation Using Machine Learning Models

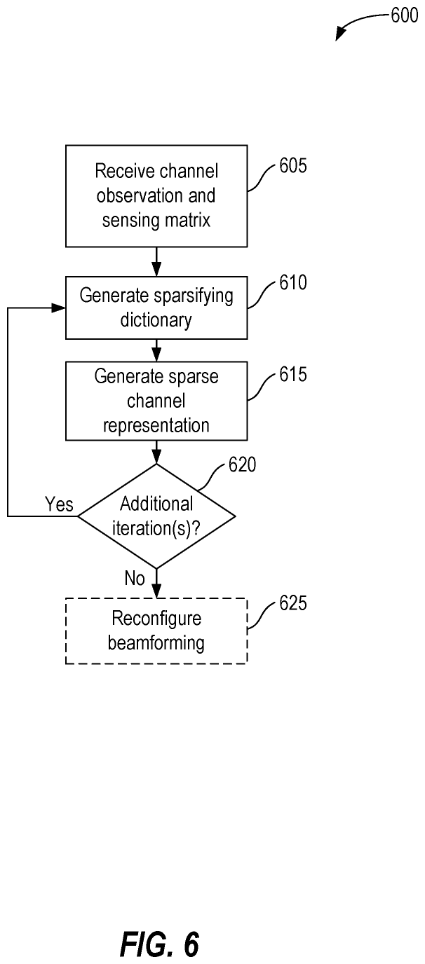

FIG. 6 is a flow diagram depicting an example method for performing channel estimation using machine learning models. In some aspects, the method 600 is performed by an estimation component, such as estimation component 145 of FIG. 1. In some aspects, the method 600 is performed by an inferencing device or system. In at least one aspect, the method 600 is performed by the user equipment participating in the wireless communication. In some aspects, the method 600 can additionally or alternatively be performed by the base station participating in the communications.

At block 605, the inferencing system determines, identifies, receives, or otherwise accesses a data sample including a channel observation (e.g., observation 210 of FIG. 2) and a sensing matrix (e.g., sensing matrix 205 of FIG. 2). In some aspects, as discussed above, the channel observation corresponds to a wireless signal as observed or measured by a receiving device or system, and the sensing matrix is defined based on the parameters used to transmit and/or receive the signal (e.g., the beamforming codebooks used by the transmitter and receiver).

In some aspects, the channel observation and sensing matrix may generally be determined or received as part of a data sample for runtime processing, as discussed above. By evaluating such samples, the inferencing system can generate an accurate channel estimation of the wireless channel.

At block 610, the inferencing system generates a current sparsifying dictionary for the current iteration. In some aspects, as discussed above, the inferencing system generates the current sparsifying dictionary using a variational posterior distribution defined using parameters generated by a machine learning model (e.g., posterior network 310 of FIG. 3). In some aspects, as discussed above, the posterior network processes the input sensing matrix and observation, alongside the sparse channel representation generated in the previous iteration (if available), to generate the distribution parameters (e.g., the mean value and/or variance value). This distribution can then be sampled to generate the current sparsifying dictionary. In at least one aspect, as discussed above, in the first iteration (e.g., where no previous sparse channel representation is available), the inferencing system can use a standard unconditional Gaussian distribution (e.g., [symbol] (0, 1)) as the posterior distribution, and sample this distribution to generate the sparsifying dictionary for the first iteration.

At block 615, the inferencing system can then generate a sparse channel representation based at least in part on the generated sparsifying dictionary. In some aspects, the sparse channel representation is generated by a likelihood model (e.g., an A-DLISTA model). In some aspects, as discussed above, the inferencing system generates the current sparse channel representation using a likelihood model and/or distribution defined using parameters generated by a machine learning model (e.g., likelihood network 325 of FIG. 3). In some aspects, as discussed above, the likelihood network processes the input sensing matrix and observation, alongside the current sparsifying dictionary generated in block 610, to generate the distribution parameters (e.g., the mean value and/or variance value). This distribution (generated using the generated parameters) can then be used as the sparse channel representation (or can be sampled to generate the sparse channel representation).

At block 620, the inferencing system determines whether there is at least one additional iteration, layer, or block remaining in the model. That is, the inferencing system can determine whether the iteration processed at blocks 610 and 615 was the last or final iteration specified in the model architecture. If there is at least one additional iteration remaining, then the method 600 returns to block 610, where the inferencing system can generate a new sparsifying dictionary based at least in part on processing the current sparse channel representation (which was generated at block 615 using the prior/initial sparsifying dictionary) using the next layer, block, or iteration of the model. In this way, the method 600 can proceed to process data through each iteration of the model, iteratively refining or updating the sparse channel representations as the sparse channel representations pass through each layer.

Although the illustrated example depicts the one or more termination criteria as a number of iterations, in some aspects, as discussed above, the inferencing system may use one or more other criteria (such as the entropy of the likelihood model) to determine whether to process additional iterations.

If no further iterations remain (or one or more other termination criteria are met), then the method 600 continues to block 625. At block 625, the inferencing system can then use the sparse channel representation to generate or recover the channel estimation (as discussed above). This channel estimation can then be used to reconfigure, refine, or otherwise improve the wireless communications, such as by redefining the beamforming configuration. For example, as discussed above, the channel estimation can be used to inform or drive analog beamforming design, to enable faster and more accurate beam selection for the communication, and/or to provide improved spectral efficiency predictions.

### Example Method for Generating Channel Estimations

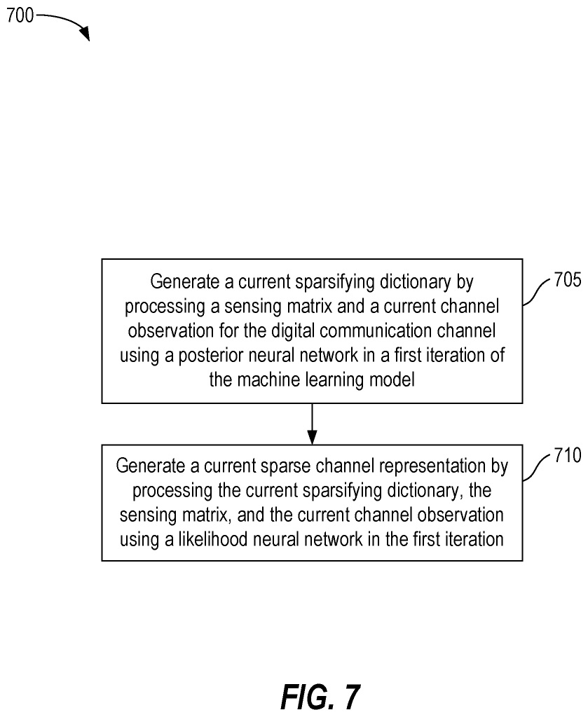

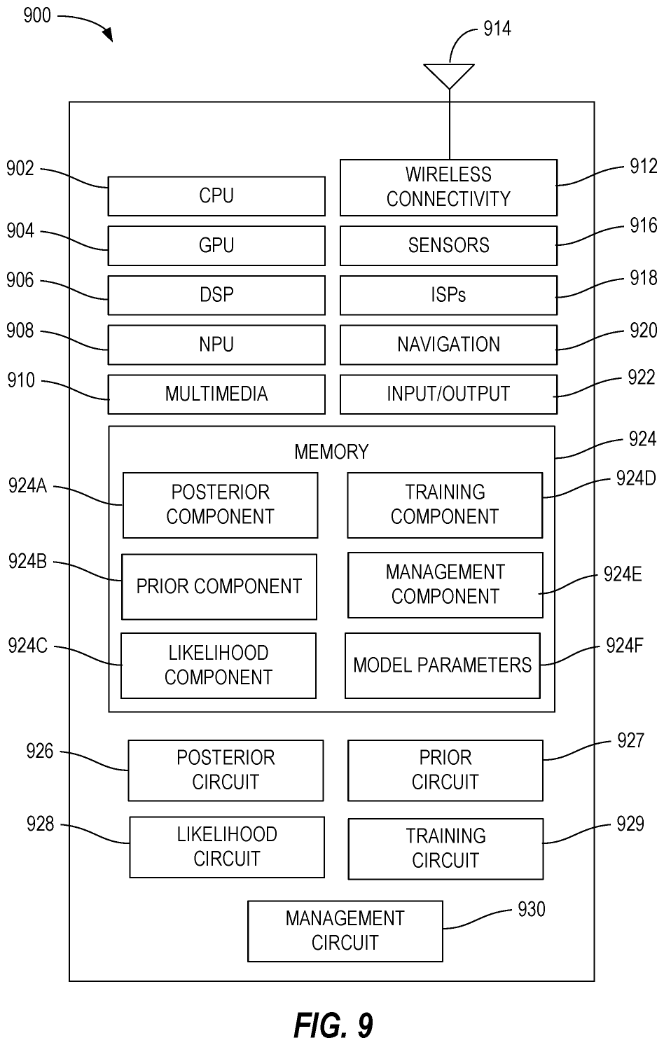

FIG. 7 is a flow diagram depicting an example method 700 for generating channel estimations. In some aspects, the method 700 is performed by an estimation component, such as estimation component 145 of FIG. 1. In some aspects, the method 700 is performed by the user equipment participating in the wireless communication. In some aspects, the method 700 can additionally or alternatively be performed by the base station participating in the communications. In at least one aspect, the method 700 is performed by a processing system, such as processing system 900 of FIG. 9.

At block 705, a current sparsifying dictionary is generated by processing a sensing matrix and a current channel observation for the digital communication channel using a posterior neural network in a first iteration of the machine learning model.

At block 710, a current sparse channel representation is generated by processing the current sparsifying dictionary, the sensing matrix, and the current channel observation using a likelihood neural network in the first iteration.

In some aspects, generating the current sparsifying dictionary using the posterior neural network comprises: generating a mean value and a variance value by processing the sensing matrix, the current channel observation, and a previous sparse channel representation generated in a previous iteration of the machine learning model, using the posterior neural network; and sampling a distribution having the mean value and the variance value.

In some aspects, the distribution is a posterior distribution defined as q_{ϕ}(Ψₜ|\hat{x}ₜ₋₁, y, Φ), wherein: \hat{x}ₜ₋₁ is the current sparsifying dictionary, \hat{x}ₜ₋₁ is the previous sparse channel representation generated in a previous iteration of the machine learning model, y is the current channel observation, and Φ is the sensing matrix.

In some aspects, the posterior distribution is equal to [symbol] (μ=f_{ϕ}(ĥₜ₋₁, y, Φ); β⁻¹=f_{ϕ}(ĥₜ₋₁, y, Φ)), wherein: μ is the mean value, f_{ϕ} is the posterior neural network, and β⁻¹ is the precision value.

In some aspects, generating the current sparse channel representation using the likelihood neural network comprises: generating a mean value by processing the current sparsifying dictionary, the sensing matrix, and the current channel observation using the likelihood neural network; and generating a distribution having the mean value and a variance value.

In some aspects, the distribution is a likelihood model defined as p_{Θ}(\hat{x}ₜ=x_{gt}|Ψ_{1:t}, y, Φ), wherein: \hat{x}ₜ is the current sparse channel representation, x_{gt} corresponds to a ground truth channel state, Ψ_{1:t} is sparsifying dictionaries generated in one or more previous iterations in the machine learning model, y is the current channel observation, and Φ is the sensing matrix.

In some aspects, the likelihood model is equal to [symbol] (μ=ADLISTA(Ψ_{1:t}, y, Φ; Θ); σ²), wherein: μ is the mean value, ADLISTA(·) represents application of the likelihood neural network, Θ is trained parameters of the likelihood neural network, and σ² is the variance value, wherein the variance value is a hyperparameter.

In some aspects, the method 700 further comprises: generating an uncertainty measurement using the likelihood neural network; determining that the uncertainty measurement satisfies one or more defined criteria; and in response to determining that the uncertainty measurement satisfies the one or more defined criteria, initiating re-training of the posterior neural network and the likelihood neural network.

In some aspects, the method 700 further comprises: determining an entropy based on the likelihood neural network; determining that the entropy satisfies one or more defined criteria; and in response to determining that the entropy satisfies the one or more defined criteria: refraining from processing the sensing matrix and the current channel observation using a subsequent iteration of the machine learning model, generating a current channel estimation based on the sparse channel representation, and outputting the current channel estimation.

In some aspects, the posterior neural network and the likelihood neural network are shared across each iteration of the machine learning model.

In some aspects, each respective iteration of the machine learning model has a respective posterior neural network and a respective likelihood neural network.

In some aspects, the digital communication channel comprises a millimeter wave digital communication channel.

In some aspects, the method 700 further comprises performing one of analog beamforming, beam selection, or spectral efficiency prediction based on the current sparse channel representation.

In some aspects, the method 700 further comprises: generating a first loss by processing the current sparsifying dictionary using a prior neural network; generating a second loss based on the current sparse channel representation; and refining the posterior neural network, the likelihood neural network, and the prior neural network based on the first loss and the second loss.

In some aspects, generating the first loss using the prior neural network comprises: generating a mean value and a variance value by processing a previous sparsifying dictionary generated in a previous iteration of the machine learning model using the prior neural network; and generating a distribution having the mean value and the variance value.

In some aspects, the distribution is a prior distribution defined as p_{θ}(Ψₜ|Ψₜ₋₁), wherein: Ψₜ is the current sparsifying dictionary, and Ψₜ₋₁ is the previous sparsifying dictionary generated in the previous iteration of the machine learning model.

In some aspects, the prior distribution is equal to [symbol] (μ=f_{θ}(Ψₜ₋₁); σ²=f_{θ}(Ψₜ₋₁), wherein: μ is the mean value, f_{θ} is the prior neural network, and σ² is the variance value.

In some aspects, the previous iteration corresponds to an input iteration of the machine learning model, and the previous sparsifying dictionary is sampled from a Gaussian distribution [symbol] (0, 1).

In some aspects, the first loss and the second loss are collectively defined as

$${\sum }_{t = 1}^{T} {𝔼}_{{Ψ}_{1 : t} ∼ {q}_{ϕ} ( {Ψ}_{1 : t} \vert y , Φ , {\hat{x}}_{0 : t - 1} )} [ log {p}_{Θ} ( {\hat{x}}_{t} = {x}_{g t} \vert {Ψ}_{1 : t} , y , Φ ) ] - {\sum }_{t = 2}^{T} {𝔼}_{{Ψ}_{1 : t} ∼ {q}_{ϕ} ( {Ψ}_{1 : t - 1} \vert y , Φ , {\hat{x}}_{t - 1} )} [ {D}_{K L} ( {q}_{ϕ} ( {Ψ}_{t} \vert y , Φ , {\hat{x}}_{t - 1} ) ‖ {p}_{θ} ( {Ψ}_{t} \vert {Ψ}_{t - 1} ) ) ] - {D}_{K L} ( {q}_{ϕ} ( {Ψ}_{1} \vert {\hat{x}}_{0} ) ‖ p ( {Ψ}_{1} ) ) ,$$

wherein: [symbol] _{Ψ}_{_{1:t}}_{˜q}_{_{ϕ}}_{(Ψ}_{_{1:t}}_{|y, Φ, \hat{x}}_{_{0:t−1}}₎ is an expected value evaluated on sparsifying dictionaries sampled up to iteration t, \hat{x}_{0:t-1} are sparse channel representations generated up to iteration t−1, x_{gt} is a ground-truth sparse channel representation, y is a channel observation, Φ is a sensing matrix, and [symbol] _{Ψ}_{_{1:t}}_{˜q}_{_{ϕ}}_{(Ψ}_{_{1:t}}_{|y, Φ, \hat{x}}_{_{0:t−1}}₎ is an expected value evaluated on sparsifying dictionaries sampled up to iteration t−1.

### Example Method for Training Machine Learning Models for Channel Estimations

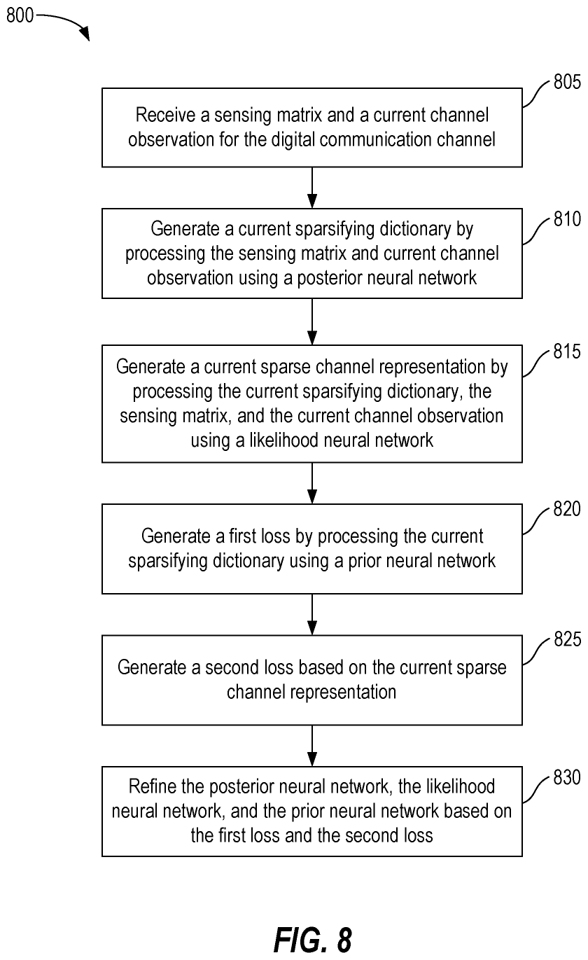

FIG. 8 is a flow diagram depicting an example method 800 for training machine learning models for channel estimation. In some aspects, the method 800 is performed by an estimation component, such as estimation component 145 of FIG. 1. In some aspects, the method 800 is performed by the user equipment participating in the wireless communication. In some aspects, the method 800 can additionally or alternatively be performed by the base station participating in the communications. In at least one aspect, the method 800 is performed by a processing system, such as processing system 900 of FIG. 9.

At block 805, a sensing matrix and a current channel observation for the digital communication channel are received.

At block 810, a current sparsifying dictionary is generated by processing the sensing matrix and current channel observation using a posterior neural network.

At block 815, a current sparse channel representation is generated by processing the current sparsifying dictionary, the sensing matrix, and the current channel observation using a likelihood neural network.

At block 820, a first loss is generated by processing the current sparsifying dictionary using a prior neural network.

At block 825, a second loss is generated based on the current sparse channel representation.

At block 830, the posterior neural network, the likelihood neural network, and the prior neural network are refined based on the first loss and the second loss.

In some aspects, generating the first loss using the prior neural network comprises: generating a mean value and a variance value by processing a previous sparsifying dictionary generated in a previous iteration of the machine learning model using the prior neural network; and generating a distribution having the mean value and the variance value.

In some aspects, the distribution is a prior distribution defined as p_{θ}(Ψₜ|Ψₜ₋₁), wherein: Ψₜ is the current sparsifying dictionary, and Ψₜ₋₁ is the previous sparsifying dictionary generated in the previous iteration of the machine learning model.

In some aspects, the prior distribution is equal to [symbol] (μ=(f_{θ}(Ψₜ₋₁); σ²=f_{θ}(Ψₜ₋₁), wherein: μ is the mean value, f_{θ} is the prior neural network, and σ² is the variance value.

In some aspects, the previous iteration corresponds to an input iteration of the machine learning model, and the previous sparsifying dictionary is sampled from a Gaussian distribution [symbol] (0, 1).

In some aspects, the first loss and the second loss are collectively defined

$${\sum }_{t = 1}^{T} {𝔼}_{{Ψ}_{1 : t} ∼ {q}_{ϕ} ( {Ψ}_{1 : t} \vert y , Φ , {\hat{x}}_{0 : t - 1} )} [ log {p}_{Θ} ( {\hat{x}}_{t} = {x}_{g t} \vert {Ψ}_{1 : t} , y , Φ ) ] - {\sum }_{t = 2}^{T} {𝔼}_{{Ψ}_{1 : t} ∼ {q}_{ϕ} ( {Ψ}_{1 : t - 1} \vert y , Φ , {\hat{x}}_{t - 1} )} [ {D}_{K L} ( {q}_{ϕ} ( {Ψ}_{t} \vert y , Φ , {\hat{x}}_{t - 1} ) ‖ {p}_{θ} ( {Ψ}_{t} \vert {Ψ}_{t - 1} ) ) ] - {D}_{K L} ( {q}_{ϕ} ( {Ψ}_{1} \vert {\hat{x}}_{0} ) ‖ p ( {Ψ}_{1} ) ) ,$$

wherein: [symbol] _{Ψ}_{_{1:t}}_{˜q}_{_{ϕ}}_{(Ψ}_{_{1:t}}_{|y, Φ, \hat{x}}_{_{0:t−1}}₎ is an expected value evaluated on sparsifying dictionaries sampled up to iteration t, \hat{x}_{0:t-1} are sparse channel representations generated up to iteration t−1, x_{gt} is a ground-truth sparse channel representation, y is a channel observation, Φ is a sensing matrix, and [symbol] _{Ψ}_{_{1:t}}_{˜q}_{_{ϕ}}_{(Ψ}_{_{1:t}}_{|y, Φ, \hat{x}}_{_{0:t−1}}₎ is an expected value evaluated on sparsifying dictionaries sampled up to iteration t−1.

In some aspects, generating the current sparsifying dictionary using the machine learning model comprising the posterior neural network comprises: generating a mean value and a precision value by processing the sensing matrix, the current channel observation, and a previous sparse channel representation generated in a previous iteration of the machine learning model, using the posterior neural network; and sampling a distribution having the mean value and the variance value.

In some aspects, the distribution is a posterior distribution defined as q_{ϕ}(Ψₜ|\hat{x}ₜ₋₁, y, Φ), wherein: Ψₜ is the current sparsifying dictionary, \hat{x}ₜ₋₁ is the previous sparse channel representation generated in a previous iteration of the machine learning model, y is the current channel observation, and Φ is the sensing matrix.

In some aspects, the posterior distribution is equal to [symbol] (μ=f_{θ}(\hat{x}ₜ₋₁, y, Φ); β⁻¹=f_{ϕ}(\hat{x}ₜ₋₁, y, Φ), wherein: μ is the mean value, f_{ϕ} is the posterior neural network, and β⁻¹ is the precision value.

In some aspects, generating the current sparse channel representation using the likelihood neural network comprises: generating a mean value by processing the current sparsifying dictionary, the sensing matrix, and the current channel observation using the likelihood neural network; and generating a distribution having the mean value and a variance value.

In some aspects, the distribution is a likelihood model defined as p_{Θ}(\hat{x}ₜ=x_{gt}|Ψ_{1:t}, y, Φ), wherein: \hat{x}ₜ is the current sparse channel representation, x_{gt} is a ground truth sparse channel representation, Ψ_{1:t} is sparsifying dictionaries generated in one or more previous iterations in the machine learning model, y is the current channel observation, and Φ is the sensing matrix.

In some aspects, the likelihood model is equal to [symbol] (μ=ADLISTA(Ψ_{1:t}, y, Φ; Θ); σ²), wherein: μ is the mean value, ADLISTA(·) represents application of the likelihood neural network, Θ is trained parameters of the likelihood neural network, and σ² is the variance value, wherein the variance value is a hyperparameter.

In some aspects, the posterior neural network and the likelihood neural network are shared across each iteration of the machine learning model.

In some aspects, each respective iteration of the machine learning model has a respective posterior neural network and a respective likelihood neural network.

In some aspects, the digital communication channel comprises a millimeter wave digital communication channel.

### Example Processing System for Improved Channel Estimation

In some aspects, the workflows, techniques, and methods described with reference to FIGS. 1-8 may be implemented on one or more devices or systems. FIG. 9 depicts an example processing system 900 configured to perform various aspects of the present disclosure, including, for example, the techniques and methods described with respect to FIGS. 1-8. In some aspects, the processing system 900 may correspond to a computing system that trains machine learning models (e.g., a training system) and/or to a computing system that uses the trained models for inferencing (e.g., an inferencing system). In some aspects, the processing system 900 corresponds to a base station and/or to user equipment engaged in a wireless communication. Although depicted as a single system for conceptual clarity, in at least some aspects, as discussed above, the operations described below with respect to the processing system 900 may be distributed across any number of devices. For example, a first system may train the model(s) while a second system uses the trained models to generate sparse channel representations/channel estimations.

Processing system 900 includes a central processing unit (CPU) 902, which in some examples may be a multi-core CPU. Instructions executed at the CPU 902 may be loaded, for example, from a program memory associated with the CPU 902 or may be loaded from a partition of memory 924.

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

An NPU, such as NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process the data through an already trained model to generate a model output (e.g., an inference).

In some implementations, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes a posterior component 924A, a prior component 924B, a likelihood component 924C, a training component 924D, and a management component 924E. The memory 924 also includes a set of model parameters 924F. The model parameters 924F may generally correspond to the parameters of all or a part of a machine learning model trained for reconstructing sparse channel representations (e.g., for channel estimation), such as one or more parameters of the likelihood model used for one or more layers of a neural network (e.g., step sizes and/or threshold values), one or more parameters of the posterior network used for one or more layers of a neural network, one or more parameters of the prior network used for one or more layers of a neural network, and the like.

Although not included in the illustrated example, in some aspects, the memory 924 also includes training data, which generally corresponds to the training samples or exemplars discussed above, such as pairs of channel observations and sensing matrices (along with corresponding ground-truth channel states). The depicted components, and others not depicted, may be configured to perform various aspects of the techniques described herein. Though depicted as discrete components for conceptual clarity in FIG. 9, posterior component 924A, prior component 924B, likelihood component 924C, training component 924D, and management component 924E may be collectively or individually implemented in various aspects.

Processing system 900 further comprises posterior circuit 926, prior circuit 927, likelihood circuit 928, training circuit 929, and management circuit 930. The depicted circuits, and others not depicted, may be configured to perform various aspects of the techniques described herein.

For example, posterior component 924A and posterior circuit 926 may be used to generate variational posterior distributions using trained neural networks, as well as to sample sparsifying dictionaries from these distributions, as discussed above. Prior component 924B and prior circuit 927 may be used to generate prior distributions using trained neural networks, as discussed above. Likelihood component 924C and likelihood circuit 928 may use likelihood model(s) (e.g., A-DLISTA models) to generate sparse channel representations based on generated sparsifying dictionaries, as discussed above. Training component 924D and training circuit 929 may correspond to the training component 345 of FIG. 3, and may be used to compute losses and/or to refine the machine learning models, as discussed above. Management component 924E and management circuit 930 may be used to orchestrate the overall workflow (e.g., the training and/or inferencing) using the above components, and/or to drive network reconfigurations based on the channel estimates (generated based on sparse channel representations), as discussed above.

Though depicted as separate components and circuits for clarity in FIG. 9, posterior circuit 926, prior circuit 927, likelihood circuit 928, training circuit 929, and management circuit 930 may collectively or individually be implemented in other processing devices of processing system 900, such as within CPU 902, GPU 904, DSP 906, NPU 908, and the like.

Generally, processing system 900 and/or components thereof may be configured to perform the methods described herein.

Notably, in other aspects, aspects of processing system 900 may be omitted, such as where processing system 900 is a server computer or the like. For example, multimedia processing unit 910, wireless connectivity component 912, sensor processing units 916, ISPs 918, and/or navigation processor 920 may be omitted in other aspects. Further, aspects of processing system 900 maybe distributed between multiple devices.

### Example Clauses

Implementation examples are described in the following numbered clauses:
Clause 1: A processor-implemented method for channel estimation of a digital communication channel using a machine learning model, comprising: generating a current sparsifying dictionary by processing a sensing matrix and a current channel observation for the digital communication channel using a posterior neural network in a first iteration of the machine learning model; and generating a current sparse channel representation by processing the current sparsifying dictionary, the sensing matrix, and the current channel observation using a likelihood neural network in the first iteration.
Clause 2: A method according to Clause 1, wherein generating the current sparsifying dictionary using the posterior neural network comprises: generating a mean value and a variance value by processing the sensing matrix, the current channel observation, and a previous sparse channel representation generated in a previous iteration of the machine learning model, using the posterior neural network; and sampling a distribution having the mean value and the variance value.
Clause 3: A method according to any of Clauses 1-2, wherein the distribution is a posterior distribution defined as q_{ϕ}(Ψₜ|\hat{x}ₜ₋₁, y, Φ), wherein: Ψₜ is the current sparsifying dictionary, \hat{x}ₜ₋₁ is the previous sparse channel representation generated in a previous iteration of the machine learning model, y is the current channel observation, and Φ is the sensing matrix.
Clause 4: A method according to any of Clauses 1-3, wherein the posterior distribution is equal to [symbol] (μ=f_{ϕ}(\hat{x}ₜ₋₁, y, Φ); β⁻¹=f_{ϕ}(\hat{x}ₜ₋₁, y, Φ)), wherein: μ is the mean value, f_{ϕ} is the posterior neural network, and β⁻¹ is the precision value.
Clause 5: A method according to any of Clauses 1-4, wherein generating the current sparse channel representation using the likelihood neural network comprises: generating a mean value by processing the current sparsifying dictionary, the sensing matrix, and the current channel observation using the likelihood neural network; and generating a distribution having the mean value and a variance value.
Clause 6: A method according to any of Clauses 1-5, wherein the distribution is a likelihood model defined as p_{Θ}(\hat{x}ₜ=x_{gt}|Ψ_{1:t}, y, Φ), wherein: \hat{x}ₜ is the current sparse channel representation, x_{gt} is a ground truth sparse channel representation, Ψ_{1:t} is sparsifying dictionaries generated in one or more previous iterations in the machine learning model, y is the current channel observation, and Φ is the sensing matrix.
Clause 7: A method according to any of Clauses 1-6, wherein the likelihood model is equal to [symbol] (μ=ADLISTA(Ψ_{1:t}, y, Φ; Θ); σ²), wherein: μ is the mean value, ADLISTA(·) represents application of the likelihood neural network, Θ is trained parameters of the likelihood neural network, and σ² is the variance value, wherein the variance value is a hyperparameter.
Clause 8: A method according to any of Clauses 1-7, further comprising: generating an uncertainty measurement using the likelihood neural network; determining that the uncertainty measurement satisfies one or more defined criteria; and in response to determining that the uncertainty measurement satisfies the one or more defined criteria, initiating re-training of the posterior neural network and the likelihood neural network.
Clause 9: A method according to any of Clauses 1-8, further comprising: determining an entropy based on the likelihood neural network; determining that the entropy satisfies one or more defined criteria; and in response to determining that the entropy satisfies the one or more defined criteria: refraining from processing the sensing matrix and the current channel observation using a subsequent iteration of the machine learning model; generating a current channel estimation based on the current sparse channel representation; and outputting the current channel estimation.
Clause 10: A method according to any of Clauses 1-9, wherein the posterior neural network and the likelihood neural network are shared across each iteration of the machine learning model.
Clause 11: A method according to any of Clauses 1-10, wherein each respective iteration of the machine learning model has a respective posterior neural network and a respective likelihood neural network.
Clause 12: A method according to any of Clauses 1-11, wherein the digital communication channel comprises a millimeter wave digital communication channel.
Clause 13: A method according to any of Clauses 1-12, further comprising performing one of analog beamforming, beam selection, or spectral efficiency prediction based on the current sparse channel representation.
Clause 14: A method according to any of Clauses 1-13, further comprising: generating a first loss by processing the current sparsifying dictionary using a prior neural network; generating a second loss based on the current sparse channel representation; and refining the posterior neural network, the likelihood neural network, and the prior neural network based on the first loss and the second loss.
Clause 15: A method according to any of Clauses 1-14, wherein generating the first loss using the prior neural network comprises: generating a mean value and a variance value by processing a previous sparsifying dictionary generated in a previous iteration of the machine learning model using the prior neural network; and generating a distribution having the mean value and the variance value.
Clause 16: A method according to any of Clauses 1-15, wherein the distribution is a prior distribution defined as p_{θ}(Ψₜ₋₁|Ψₜ₋₁), wherein: Ψₜ is the current sparsifying dictionary, and Ψₜ₋₁ is the previous sparsifying dictionary generated in the previous iteration of the machine learning model.
Clause 17: A method according to any of Clauses 1-16, wherein the prior distribution is equal to [symbol] (μ=f_{θ}(Ψₜ₋₁); σ²=f_{θ}(Ψₜ₋₁), wherein: μ is the mean value, f_{θ} is the prior neural network, and σ² is the variance value.
Clause 18: A method according to any one of Clauses 1-17, wherein: the previous iteration corresponds to an input iteration of the machine learning model, and the previous sparsifying dictionary is sampled from a Gaussian distribution [symbol] (0, 1).
Clause 19: A method according to any of Clauses 1-18, wherein the first loss and the second loss are collectively defined as

$${\sum }_{t = 1}^{T} {𝔼}_{{Ψ}_{1 : t} ∼ {q}_{ϕ} ( {Ψ}_{1 : t} \vert y , Φ , {\hat{x}}_{0 : t - 1} )} [ log {p}_{Θ} ( {\hat{x}}_{t} = {x}_{g t} \vert {Ψ}_{1 : t} , y , Φ ) ] - {\sum }_{t = 2}^{T} {𝔼}_{{Ψ}_{1 : t} ∼ {q}_{ϕ} ( {Ψ}_{1 : t - 1} \vert y , Φ , {\hat{x}}_{t - 1} )} [ {D}_{K L} ( {q}_{ϕ} ( {Ψ}_{t} \vert y , Φ , {\hat{x}}_{t - 1} ) ‖ {p}_{θ} ( {Ψ}_{t} \vert {Ψ}_{t - 1} ) ) ] - {D}_{K L} ( {q}_{ϕ} ( {Ψ}_{1} \vert {\hat{x}}_{0} ) ‖ p ( {Ψ}_{1} ) ) ,$$

wherein: [symbol] _{Ψ}_{_{1:t}}_{˜q}_{_{ϕ}}_{(Ψ}_{_{1:t}}_{|y, Φ, \hat{x}}_{_{0:t−1}}₎ is an expected value evaluated on sparsifying dictionaries sampled up to iteration t, \hat{x}_{0:t-1} are sparse channel representations generated up to iteration t−1, x_{gt} is a ground-truth sparse channel representation, y is a channel observation, P is a sensing matrix, and [symbol] _{Ψ}_{_{1:t}}_{˜q}_{_{ϕ}}_{(Ψ}_{_{1:t}}_{|y, Φ, \hat{x}}_{_{0:t−1}}₎ is an expected value evaluated on sparsifying dictionaries sampled up to iteration t−1.
Clause 20: A processor-implemented method for training a machine learning model for channel estimation of a digital communication channel, comprising: receiving a sensing matrix and a current channel observation for the digital communication channel; generating a current sparsifying dictionary by processing the sensing matrix and current channel observation using a posterior neural network; generating a current sparse channel representation by processing the current sparsifying dictionary, the sensing matrix, and the current channel observation using a likelihood neural network; generating a first loss by processing the current sparsifying dictionary using a prior neural network; generating a second loss based on the current sparse channel representation; and refining the posterior neural network, the likelihood neural network, and the prior neural network based on the first loss and the second loss.
Clause 21: A method according to Clause 20, wherein generating the first loss using the prior neural network comprises: generating a mean value and a variance value by processing a previous sparsifying dictionary generated in a previous iteration of the machine learning model using the prior neural network; and generating a distribution having the mean value and the variance value.
Clause 22: A method according to any of Clauses 20-21, wherein the distribution is a prior distribution defined as p_{θ}(Ψₜ|Ψₜ₋₁), wherein: Ψₜ is the current sparsifying dictionary, and Ψₜ₋₁ is the previous sparsifying dictionary generated in the previous iteration of the machine learning model.
Clause 23: A method according to any of Clauses 20-22, wherein the prior distribution is equal to [symbol] (μ=f_{θ}(Ψₜ₋₁); σ²=f_{θ}(Ψₜ₋₁), wherein: μ is the mean value, f_{θ} is the prior neural network, and σ² is the variance value.
Clause 24: A method according to any of Clauses 20-23, wherein: the previous iteration corresponds to an input iteration of the machine learning model, and the previous sparsifying dictionary is sampled from a Gaussian distribution [symbol] (0, 1).
Clause 25: A method according to any of Clauses 20-24, wherein the first loss and the second loss are collectively defined as

$${\sum }_{t = 1}^{T} {𝔼}_{{Ψ}_{1 : t} ∼ {q}_{ϕ} ( {Ψ}_{1 : t} \vert y , Φ , {\hat{x}}_{0 : t - 1} )} [ log {p}_{Θ} ( {\hat{x}}_{t} = {x}_{g t} \vert {Ψ}_{1 : t} , y , Φ ) ] - {\sum }_{t = 2}^{T} {𝔼}_{{Ψ}_{1 : t} ∼ {q}_{ϕ} ( {Ψ}_{1 : t - 1} \vert y , Φ , {\hat{x}}_{t - 1} )} [ {D}_{K L} ( {q}_{ϕ} ( {Ψ}_{t} \vert y , Φ , {\hat{x}}_{t - 1} ) ‖ {p}_{θ} ( {Ψ}_{t} \vert {Ψ}_{t - 1} ) ) ] - {D}_{K L} ( {q}_{ϕ} ( {Ψ}_{1} \vert {\hat{x}}_{0} ) ‖ p ( {Ψ}_{1} ) ) ,$$

wherein: [symbol] _{Ψ}_{_{1:t}}_{˜q}_{_{ϕ}}_{(Ψ}_{_{1:t}}_{|y, Φ, \hat{x}}_{_{0:t−1}}₎ is an expected value evaluated on sparsifying dictionaries sampled up to iteration t, \hat{x}_{0:t-1} are sparse channel representations generated up to iteration t−1, x_{gt} is a ground-truth sparse channel representation, y is a channel observation, Φ is a sensing matrix, and [symbol] _{Ψ}_{_{1:t}}_{˜q}_{_{ϕ}}_{(Ψ}_{_{1:t}}_{|y, Φ, \hat{x}}_{_{0:t−1}}₎ is an expected value evaluated on sparsifying dictionaries sampled up to iteration t−1.
Clause 26: A method according to any of Clauses 20-25, wherein generating the current sparsifying dictionary using the machine learning model comprising the posterior neural network comprises: generating a mean value and a precision value by processing the sensing matrix, the current channel observation, and a previous sparse channel representation generated in a previous iteration of the machine learning model, using the posterior neural network; and sampling a distribution having the mean value and the variance value.
Clause 27: A method according to any of Clauses 20-26, wherein the distribution is a posterior distribution defined as q_{ϕ}(Ψₜ|\hat{x}ₜ₋₁, y, Φ), wherein: Ψₜ is the current sparsifying dictionary, \hat{x}ₜ₋₁ is the previous sparse channel representation generated in a previous iteration of the machine learning model, y is the current channel observation, and Φ is the sensing matrix.
Clause 28: A method according to any of Clauses 20-27, wherein the posterior distribution is equal to [symbol] (μ=f_{Φ}(\hat{x}ₜ₋₁, y, Φ); β⁻¹, y, Φ)), wherein: μ is the mean value, f_{ϕ} is the posterior neural network, and β⁻¹ is the precision value.
Clause 29: A method according to any of Clauses 20-28, wherein generating the current sparse channel representation using the likelihood neural network comprises: generating a mean value by processing the current sparsifying dictionary, the sensing matrix, and the current channel observation using the likelihood neural network; and generating a distribution having the mean value and a variance value.
Clause 30: A method according to any of Clauses 20-29, wherein the distribution is a likelihood model defined as p_{Θ}(\hat{x}ₜ=x_{gt}|Ψ_{1:t}, y, Φ), wherein: \hat{x}ₜ is the current sparse channel representation, x_{gt} is a ground truth sparse channel representation, Ψ_{1:t} is sparsifying dictionaries generated in one or more previous iterations in the machine learning model, y is the current channel observation, and Φ is the sensing matrix.
Clause 31: A method according to any of Clauses 20-30, wherein the likelihood model is equal to [symbol] (μ=ADLISTA(Ψ_{1:t}, y, Φ; Θ); σ²), wherein: μ is the mean value, ADLISTA(·) represents application of the likelihood neural network, Θ is trained parameters of the likelihood neural network, and σ² is the variance value, wherein the variance value is a hyperparameter.
Clause 32: A method according to any of Clauses 20-31, wherein the posterior neural network and the likelihood neural network are shared across each iteration of the machine learning model.
Clause 33: A method according to any of Clauses 20-32, wherein each respective iteration of the machine learning model has a respective posterior neural network and a respective likelihood neural network.
Clause 34: A method according to any of Clauses 20-33, wherein the digital communication channel comprises a millimeter wave digital communication channel.
Clause 35: A processing system, comprising: a memory comprising computer-executable instructions; and one or more processors configured to execute the computer-executable instructions and cause the processing system to perform a method in accordance with any of Clauses 1-34.
Clause 36: A processing system, comprising means for performing a method in accordance with any of Clauses 1-34.
Clause 37: A non-transitory computer-readable medium comprising computer-executable instructions that, when executed by one or more processors of a processing system, cause the processing system to perform a method in accordance with any of Clauses 1-34.
Clause 38: A computer program product embodied on a computer-readable storage medium comprising code for performing a method in accordance with any of Clauses 1-34.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
generating a current sparsifying dictionary by processing a sensing matrix and a current channel observation for a digital communication channel using a posterior neural network in a first iteration of a machine learning model; and
generating a current sparse channel representation by processing the current sparsifying dictionary, the sensing matrix, and the current channel observation using a likelihood neural network in the first iteration.

2. The processor-implemented method of claim 1, wherein generating the current sparsifying dictionary using the posterior neural network comprises:
generating a mean value and a variance value by processing the sensing matrix, the current channel observation, and a previous sparse channel representation generated in a previous iteration of the machine learning model, using the posterior neural network; and
sampling a distribution having the mean value and the variance value.

3. The processor-implemented method of claim 2, wherein the distribution is a posterior distribution defined as q_{ϕ}(Ψₜ|\hat{x}ₜ₋₁, y, Φ), wherein:
Ψₜ is the current sparsifying dictionary,
\hat{x}ₜ₋₁ is the previous sparse channel representation generated in a previous iteration of the machine learning model,
y is the current channel observation, and
Φ is the sensing matrix.

4. The processor-implemented method of claim 1, wherein generating the current sparse channel representation using the likelihood neural network comprises:
generating a mean value by processing the current sparsifying dictionary, the sensing matrix, and the current channel observation using the likelihood neural network; and
generating a distribution having the mean value and a variance value.

5. The processor-implemented method of claim 4, wherein the distribution is a likelihood model defined as p_{Θ}(\hat{x}ₜ=x_{gt}|, y, Φ), wherein:
\hat{x}ₜ is the current sparse channel representation,
x_{gt} corresponds to a ground truth channel state,
Ψ_{1:t} is sparsifying dictionaries generated in one or more previous iterations in the machine learning model,
y is the current channel observation, and
Φ is the sensing matrix.

6. The processor-implemented method of claim 1, further comprising:
generating an uncertainty measurement using the likelihood neural network;
determining that the uncertainty measurement satisfies one or more defined criteria; and
in response to determining that the uncertainty measurement satisfies the one or more defined criteria, initiating re-training of the posterior neural network and the likelihood neural network.

7. The processor-implemented method of claim 1, further comprising:
determining an entropy based on the likelihood neural network;
determining that the entropy satisfies one or more defined criteria; and
in response to determining that the entropy satisfies the one or more defined criteria:
refraining from processing the sensing matrix and the current channel observation using a subsequent iteration of the machine learning model;
generating a current channel estimation based on the current sparse channel representation; and
outputting the current channel estimation.

8. The processor-implemented method of claim 1, wherein the posterior neural network and the likelihood neural network are shared across each iteration of the machine learning model.

9. The processor-implemented method of claim 1, wherein each respective iteration of the machine learning model has a respective posterior neural network and a respective likelihood neural network.

10. The processor-implemented method of claim 1, further comprising performing one of analog beamforming, beam selection, or spectral efficiency prediction based on the current sparse channel representation.

11. The processor-implemented method of claim 1, further comprising:
generating a first loss by processing the current sparsifying dictionary using a prior neural network;
generating a second loss based on the current sparse channel representation; and
refining the posterior neural network, the likelihood neural network, and the prior neural network based on the first loss and the second loss.

12. The processor-implemented method of claim 11, wherein generating the first loss using the prior neural network comprises:
generating a mean value and a variance value by processing a previous sparsifying dictionary generated in a previous iteration of the machine learning model using the prior neural network; and
generating a distribution having the mean value and the variance value.

13. A processor-implemented method, comprising:
receiving a sensing matrix and a current channel observation for a digital communication channel;
generating a current sparsifying dictionary by processing the sensing matrix and the current channel observation using a machine learning model comprising a posterior neural network;
generating a current sparse channel representation by processing the current sparsifying dictionary, the sensing matrix, and the current channel observation using a likelihood neural network;
generating a first loss by processing the current sparsifying dictionary using a prior neural network;
generating a second loss based on the current sparse channel representation; and
refining the posterior neural network, the likelihood neural network, and the prior neural network based on the first loss and the second loss.

14. The processor-implemented method of claim 13, wherein generating the first loss using the prior neural network comprises:
generating a mean value and a variance value by processing a previous sparsifying dictionary generated in a previous iteration of the machine learning model using the prior neural network; and
generating a distribution having the mean value and the variance value.

15. The processor-implemented method of claim 14, wherein the distribution is a prior distribution defined as p_{θ}(Ψₜ|Ψₜ₋₁), wherein:
Ψₜ is the current sparsifying dictionary, and
Ψₜ₋₁ is the previous sparsifying dictionary generated in the previous iteration of the machine learning model.

16. The processor-implemented method of claim 15, wherein:
the previous iteration corresponds to an input iteration of the machine learning model, and
the previous sparsifying dictionary is sampled from a Gaussian distribution [symbol] (0, 1).

17. The processor-implemented method of claim 13, wherein generating the current sparsifying dictionary using the machine learning model comprising the posterior neural network comprises:
generating a mean value and a variance value by processing the sensing matrix, the current channel observation, and a previous sparse channel representation generated in a previous iteration of the machine learning model, using the posterior neural network; and
sampling a distribution having the mean value and the variance value.

18. The processor-implemented method of claim 13, wherein generating the current sparse channel representation using the likelihood neural network comprises:
generating a mean value by processing the current sparsifying dictionary, the sensing matrix, and the current channel observation using the likelihood neural network; and
generating a distribution having the mean value and a variance value.

19. The processor-implemented method of claim 13, wherein the posterior neural network and the likelihood neural network are shared across each iteration of the machine learning model.

20. The processor-implemented method of claim 13, wherein each respective iteration of the machine learning model has a respective posterior neural network and a respective likelihood neural network.

21. A processing system, comprising:
a memory comprising computer-executable instructions; and
one or more processors configured to execute the computer-executable instructions and cause the processing system to perform an operation, comprising:
generating a current sparsifying dictionary by processing a sensing matrix and a current channel observation for a digital communication channel using a posterior neural network in a first iteration of a machine learning model; and
generating a current sparse channel representation by processing the current sparsifying dictionary, the sensing matrix, and the current channel observation using a likelihood neural network in the first iteration.

22. The processing system of claim 21, wherein generating the current sparsifying dictionary using the posterior neural network comprises:
generating a mean value and a variance value by processing the sensing matrix, the current channel observation, and a previous sparse channel representation generated in a previous iteration of the machine learning model, using the posterior neural network; and
sampling a distribution having the mean value and variance value.

23. The processing system of claim 21, wherein generating the current sparse channel representation using the likelihood neural network comprises:
generating a mean value by processing the current sparsifying dictionary, the sensing matrix, and the current channel observation using the likelihood neural network; and
generating a distribution having the mean value and a variance value.

24. The processing system of claim 23, wherein the distribution is a likelihood model defined as p_{Θ}(\hat{x}ₜ=x_{gt}|Ψ_{1:t}, y, Φ), wherein:
\hat{x}ₜ is the current sparse channel representation,
x_{gt} corresponds to a ground truth channel state,
Ψ_{1:t} is sparsifying dictionaries generated in one or more previous iterations in the machine learning model,
y is the current channel observation, and
Φ is the sensing matrix.

25. The processing system of claim 21, the operation further comprising:
generating an uncertainty measurement using the likelihood neural network;
determining that the uncertainty measurement satisfies one or more defined criteria; and
in response to determining that the uncertainty measurement satisfies the one or more defined criteria, initiating re-training of the posterior neural network and the likelihood neural network.

26. The processing system of claim 21, the operation further comprising:
determining an entropy based on the likelihood neural network;
determining that the entropy satisfies one or more defined criteria; and
in response to determining that the entropy satisfies the one or more defined criteria:
refraining from processing the sensing matrix and the current channel observation using a subsequent iteration of the machine learning model;
generating a current channel estimation based on the current sparse channel representation and
outputting the current channel estimation.

27. The processing system of claim 21, wherein the posterior neural network and the likelihood neural network are shared across each iteration of the machine learning model.

28. The processing system of claim 21, wherein each respective iteration of the machine learning model has a respective posterior neural network and a respective likelihood neural network.

29. The processing system of claim 21, the operation further comprising performing one of analog beamforming, beam selection, or spectral efficiency prediction based on the current sparse channel representation.

30. A system, comprising:
means for generating a current sparsifying dictionary by processing a sensing matrix and a current channel observation for a digital communication channel using a posterior neural network in a first iteration of a machine learning model; and
means for generating a current sparse channel representation by processing the current sparsifying dictionary, the sensing matrix, and the current channel observation using a likelihood neural network in the first iteration.
